(19) United States
(12) Patent Application Publication
(10) Pub. No.: US 2022/0172229 A1
(43) Pub. Date: Jun. 2, 2022

(54) PRODUCT VARIOUS OPINION EVALUATION SYSTEM CAPABLE OF GENERATING SPECIAL FEATURE POINT AND METHOD THEREOF

(71) Applicant: Yun-Kai Chen, Sunnybank Hills (AU)

(72) Inventor: Yun-Kai Chen, Sunnybank Hills (AU)

(21) Appl. No.: 17/535,631

(22) Filed: Nov. 25, 2021

Related U.S. Application Data
(60) Provisional application No. 63/118,996, filed on Nov. 30, 2020.

(51) Int. Cl. G06Q 30/02; G06F 40/30

(52) U.S. Cl. CPC G06Q 30/0201; G06Q 30/0282; G06F 40/30

(57) ABSTRACT

A product various opinion evaluation system including one or more computing devices being a remote computing device and/or at least one client device communicable with the remote computing device, and a method applied therewith, can receive positive review information and negative review information related to a product that are inputted in the one or more computing devices by at least one user or through at least one product review message; perform positive and negative review semantics analysis on the positive and negative review information; generate positive and negative feature points of the product based on the positive and negative review semantics analysis; and generate at least one special feature point by merging the positive and negative feature points based on similarity therebetween, through which consumers can swiftly understand a conflict point of the product and focus of marketing can be located for the advertisers and manufacturers of the product.

### CROSS-REFERENCE TO RELATED PATENT APPLICATION

This application claims the benefit of U.S. Provisional Application No. 63/118,996, filed Nov. 30, 2020. The entire content of the above identified application is incorporated herein by reference.

### FIELD

The present disclosure relates to a various opinion evaluation system capable of generating at least one special feature point for at least one product that can be a piece of good or a service and method thereof, and more particularly to a product various opinion evaluation system that generates at least one special feature point based on positive and negative feature points of one or more products and special feature point generation method thereof.

### BACKGROUND

The primary purpose of marketing is to establish a long-term relationship with clients. Therefore, finding out the needs and desires of customers, and measuring the extent of the effort and expense that must be spent to satiate such needs and desires, as well as the potential profitability resulting therefrom, have always been major issues facing business entities. Before the Internet became popular, one of the commonly used marketing methods for goods and services was to create or find catchphrases, and then use catchphrases to promote and market goods or services. However, after the Internet becomes popular, keyword advertising, which targets consumer behavior and is more accurate, has emerged as a new way of promotion and marketing, and allows, for example, relevant advertisements to be placed according to consumer personal data, such as keywords related to age, gender, occupation, etc.; or according to consumer online behavior and data, such as the website(s) a consumer has visited, the actual location(s) where the consumer has checked in or been located, purchases made and/or the online goods the consumer has purchased or used, etc.

In comparison, traditional advertising strategies involve an advertiser presuming beforehand consumer groups such as students, white-collar workers, elderly, etc., and then paying an advertising and marketing fee to an advertising entity such as a newspaper agency, a television station, etc.; the advertising entity offering advertising content on a medium, such as a newspaper or television channel, for a fixed period of time for consumers to read and watch and for their reference; and then, the advertiser evaluating the effectiveness of such advertising. That is, traditional advertisement placement only carries out one-way advertisement casting and promoting on newspapers, magazines, radio, television, etc., and therefore is prone to the problem of advertiser-consumer mismatch.

However, in recent years, more accurate online advertisement placement can be achieved by analyzing consumer individual behavior, which greatly reduces the aforementioned problems, enables an advertiser, for example, a goods manufacturer or a service provider, to get closer to its target consumers, and enables consumers to receive less irrelevant or uninterested advertisement information. In this way, not only ineffective or lowly-effective advertising expenditures can be reduced for advertisers, but also the product information which consumers need or are interested in can be received by such consumers more quickly. Moreover, as a result of reduced ineffective advertising expenditures, consumers can enjoy cheaper products due to lowered marketing costs.

Nevertheless, the current keyword placement model of online advertising, whether based on consumer personal data or consumer online behavior, can generate too many source keywords or be not accurate enough, leading to overexposure of the source keywords preset by advertisers, increased advertising costs resulting therefrom and from keyword bidding, and increased marketing time costs. Accordingly, consumers can also be negatively impacted by retail product price increase.

For example, cosmetics advertisement placement based on consumer personal data may target Internet users who are from country T and are women aged 18-25. Or, advertising may be based on consumer online behavior and data resulting therefrom which may exemplarily include a consumer entering a keyword related to a S-brand fine watch, browsing on the official website of the S-brand fine watch, or purchasing a S-brand fine watch. In this way, when a consumer meeting the aforementioned condition(s) browses through other websites later on, advertisements of information corresponding to the product, such as a cosmetic advertisement, a S-brand fine watch advertisement, etc., will continue to appear on such websites.

Different from the fee payment methods of traditional advertising, current online keyword advertising involves consumers consuming information first, for example, pop-up advertisements popping up on webpages, consumers clicking on advertisements, etc., and then the advertising budget preset by an advertiser being deducted accordingly. That is to say, when it comes to online keyword advertising expenditures, consumers rather actively consume advertisements and advertising budgets.

Nevertheless, the aforementioned marketing fee payment methods have been known for inviting issues as detailed infra. Specifically, as an advertiser would provide specific preset advertising subjects or keywords, for example, those related to the conditions of “women aged 18-25” and “Internet users from country T” to advertising agents to place keyword advertisements, as long as a user satisfying the abovementioned conditions comes into contact with any of the advertisements placed, the budget for the advertisement is expended accordingly. Further, regardless of whether there are malicious clicks by competitors of the advertiser, such as continuously expending advertisements by using qualified users, malicious advertising contractors defrauding advertisements, such as illicit audio-visual websites generating a large number of background pages to satisfy advertisement hit conditions, or simply, different advertisers in the same industry competing for consumers in the same sector, for example, the cosmetics industry bidding for sunscreen products that target the same 18-25 year-old consumers, there will be mismatch between advertisers and consumers, which increases invalid advertising expenditures and increases product retail prices.

In addition, regarding advertisement placement based on consumer online behavior, with continued reference to the abovementioned exemplary S-brand fine watch and the conditions of “browsing the official website of the S-brand fine watch” and “purchase of the S-brand fine watch”, a current advertising model may assume that consumers are continuously interested in the S-brand fine watch, and therefore continues placing such advertisements, and the placement continues regardless of whether such a consumer, after browsing on the official website of the S-brand fine watch, decides that the S-brand watch does not meet his or her needs and leaves the official website, which can incur invalid advertising expenditures and can annoy consumers by excessive unfitting advertisements.

It can thus be known that the current methods of online keyword advertisement placement, despite its seeming convenience as compared to one-time fixed-time and fixed-amount newspaper and/or television advertisement placement, and its seeming higher precision in terms of consumer receiving advertisements that really interest them, can rather incur increased advertising cost and loss to both advertisers and consumers when the number of keywords increases and the matching accuracy remains not high enough.

On the other hand, for consumers, multitudinous advertising information on webpages has become so overwhelming, if not unbearable, that one can easily be ensnared therein before product specification information and trustworthy reviews that one really needs can be quickly found. For example, among such common online dissemination methods of merchandise information can be product placement, Internet celebrity recommendation, shopping-website buyer comments, large-online-forum user reviews, and merchandise review websites. Among such, product placement, while allowing an advertiser to determine by itself the content and format of advertisements entirely based on its interests to the maximum extent, does not directly answer to consumer needs, since it does not necessarily show the product features consumers care about. Likewise, recommendation made by an Internet celebrity can quickly attract consumers through the celebrity effect, but it does not directly answer to consumer needs and does not necessarily show the product features consumers care about. Further, while buyer comments on shopping websites may, by providing product information that has been digested and is firsthand and personal, lower consumers' prior-purchase mental barriers, as the content and format thereof are generally informal and unsystematic, consumers often need to read a lot of comments before finding comments that meet their needs, forcing consumers to spend a lot of time and effort. Furthermore, user reviews on large online forums, while being presented in a more organized and comprehensive way compared to the comments on shopping websites, their format can be too personal to be suitable for consumers having different cultural backgrounds and reading habits. In comparison, merchandise review websites may provide consumers better reading experience and efficiency because of their established basic common editorial formats for different reviews, and therefore providing relatively consistent presentation of product information even if such reviews are written by different users. Nevertheless, there is still room for improvement of the current information presentation layouts of merchandise review websites.

Specifically, a current merchandise review website may separately list the basic information and the reviews of a piece of goods in two editable areas on a webpage, so that a user may look up the basic information and the reviews of the goods on the same webpage. Further, such a webpage also bears keyword information generated by the content of the reviews, for example, by sorting out multiple keywords through specific algorithms from the content of various reviews on the goods that are inputted by multiple users in the review fields provided by the website, and a user can click on the hyperlinks of the keywords to browse on the reviews related to the keywords. Nevertheless, such keywords and the reviews related thereof are displayed regardless of their inner characters. For example, a keyword “spicy” may be used by one consumer who enjoys spicy food in a review as a positive character of a food product, while another consumer who does not enjoy spicy food so much may address the keyword “spicy” in another review as a negative character of the food product. Accordingly, when other users click on the hyperlink of the keyword “spicy”, both positive reviews and negative reviews are displayed mixedly, which requires the users to go through a lot of reviews before deciding whether to purchase the food product or not. In addition, it is also difficult for manufacturers to swiftly find out contents that are beneficial to advertising in so many reviews.

In addition, a current merchandise review website may also provide users with scoring mechanism in addition to text review features, for example, a 5-star rating system with a scale from 1 to 5 stars. Nevertheless, when a controversial incident occurs, such as a restaurant service dispute on mandatory minimum order requirement or a controversial public figure making sensational recommendation for a cuisine of a particular restaurant, such a controversial incident may instead provoke opposers to the mandatory requirement or the public figure to leave a large number of low-score reviews that are not related to the food served by these restaurants. The only ways nowadays to deal with such a problem include leaving such reviews to be handled by collaborating scoring platforms, or temporarily suspending the review function. However, even after such a topical trend is over, a large number of low scores can still stay on the review pages of a pertinent product, and lower the overall score of the goods or service. The overall score lowering, whether taking place in a mature market that already has many goods or services homogeneous to the product, or in an emerging market where recognition and acceptance of such a product is still low, would similarly impact the provider of the product negatively.

Accordingly, there is still room for improvement on the afore-referenced issues, and the present disclosure presents an opinion review evaluation system and methods thereof that involve special, positive and negative feature points to answer issues including, but not limited to, those discussed supra.

### SUMMARY

Certain aspects of the present disclosure are directed to a various opinion evaluation system including one or more computing devices that can be a remote computing device and/or at least one client device communicable with the remote computing device. The one or more computing device include one or more processors and one or more storage devices storing computer executable code. The computer executable code, when executed at the one or more processors, can: receive a piece of positive review information related to a product and a piece of negative review information related to the product through at least one product review message or inputted at the one or more computing devices by at least one user; perform positive review semantics analysis on the positive review information, and perform negative review semantics analysis on the negative review information; generate at least one positive feature point of the product based on the positive review semantics analysis, and generate at least one negative feature point of the product based on the negative review semantics analysis; and generate at least one special feature point by merging the positive feature point and the negative feature point based on similarity therebetween.

In certain embodiments, the computer executable code of the one or more computing devices, when executed at the one or more processors, can segment text of the positive review information into semantically meaningful positive keywords, and text of the negative review information into semantically meaningful negative keywords, and assign at least two of the semantically meaningful positive keywords that have semantic overlapping into the same first semantic group, and at least two of the semantically meaningful negative keywords that have semantic overlapping into the same second semantic group.

In certain embodiments, the computer executable code of the one or more computing devices, when executed at the one or more processors, can determine a first semantic overlapping degree of the first semantic group, a second semantic overlapping degree of the second semantic group, a first semantic overlapping ratio of each of the at least two semantically meaningful positive keywords in the same first semantic group, and a second semantic overlapping ratio of each of the at least two semantically meaningful negative keywords in the same second semantic group. The first semantic overlapping degree is any semantic overlapping between any two semantically meaningful positive keywords in the same first semantic group. The second semantic overlapping degree of the second semantic group is any semantic overlapping between any two semantically meaningful negative keywords in the same second semantic group. The first semantic overlapping ratio is a ratio of any semantic overlapping between the semantically meaningful positive keyword and any other semantically meaningful positive keyword in the same first semantic group to the first semantic overlapping degree. The second semantic overlapping ratio is a ratio of any semantic overlapping between the semantically meaningful negative keyword and any other semantically meaningful negative keyword in the same second semantic group to the second semantic overlapping degree.

In certain embodiments, the computer executable code of the one or more computing devices, when executed at the one or more processors, can define one of the semantically meaningful positive keywords in the same first semantic group that has a highest first semantic overlapping ratio among the first semantic overlapping ratios as the positive feature point, one of the semantically meaningful negative keywords in the same second semantic group that has a highest second semantic overlapping ratio among the second semantic overlapping ratios as the negative feature point, a first weighting value of the positive feature point as a sum of weighting values of the semantically meaningful positive keywords in the same first semantic group to which the positive feature point belongs, and a second weighting value of the negative feature point as a sum of weighting values of the semantically meaningful negative keywords in the same second semantic group to which the negative feature point belongs.

In certain embodiments, the computer executable code of the one or more computing devices, when executed at the one or more processors, can: compare the positive feature point with the negative feature point; determine whether at least one common meaningful linguistic unit exists both in the positive feature point and the negative feature point based on the comparison; and in response to determining at least one common meaningful linguistic unit exists both in the positive feature point and the negative feature point, define the common meaningful linguistic unit as the special feature point, and a weighting value of the special feature point as a sum of a first weighting value of the positive feature point and a second weighting value of the negative feature point.

In certain embodiments, the computer executable code of the one or more computing devices, when executed at the one or more processors, can generate a first numeral value according to a first weighting value of the positive feature point and a second weighting value of the negative feature point, and generate a second numeral value according to the first weighting value of the positive feature point and the second weighting value of the negative feature point; compare the positive feature point with the negative feature point; determine whether at least one common meaningful linguistic unit exists both in the positive feature point and the negative feature point based on the comparison; determine whether the common meaningful linguistic unit is the positive feature point or the negative feature point; in response to determining the common meaningful linguistic unit is the positive feature point or the negative feature point, define the positive feature point or the negative feature point as the special feature point, and define a weighting value of the special feature point as a sum of the first weighting value of the positive feature point and the second weighting value of the negative feature point; in response to determining the common meaningful linguistic unit is not the positive feature point and not the negative feature point, determine whether the first numeral value is greater than a predetermined positive-feature threshold, and determine whether the second numeral value is greater than a predetermined negative-feature threshold; in response to determining the first numeral value is greater than the predetermined positive-feature threshold, define the positive feature point as the special feature point; in response to determining the second numeral value is greater than the predetermined negative-feature threshold, define the negative feature point as the special feature point; and in response to determining the first numeral value is smaller than the predetermined positive-feature threshold and the second numeral value is smaller than the predetermined negative-feature threshold, define the common meaningful linguistic unit as the special feature point.

In certain embodiments, the computer executable code of the one or more computing devices, when executed at the one or more processors, can generate a first numeral value according to a first weighting value of the positive feature point and a second weighting value of the negative feature point, and generate a second numeral value according to the first weighting value of the positive feature point and the second weighting value of the negative feature point; compare the positive feature point with the negative feature point; determine whether at least one common meaningful linguistic unit exists both in the positive feature point and the negative feature point based on the comparison; determine whether the common meaningful linguistic unit is the positive feature point or the negative feature point; in response to determining the common meaningful linguistic unit is the positive feature point or the negative feature point, define the positive feature point or the negative feature point as the special feature point, and a weighting value of the special feature point as a sum of the first weighting value of the positive feature point and the second weighting value of the negative feature point; in response to determining no common meaningful linguistic unit exists both in the positive and negative feature points, determine whether at least one first linguistic unit in the positive feature point and at least one second linguistic unit in the negative feature point are semantically similar linguistic units; in response to determining the first and second linguistic units are semantically similar linguistic units, designate one of the first and second linguistic units as the common meaningful linguistic unit, and determine whether the first numeral value is greater than a predetermined positive-feature threshold and whether the second numeral value is greater than a predetermined negative-feature threshold; in response to determining the first numeral value is greater than the predetermined positive-feature threshold, define the positive feature point as the special feature point; in response to determining the second numeral value is greater than the predetermined negative-feature threshold, define the negative feature point as the special feature point; and in response to determining the first numeral value is smaller than the predetermined positive-feature threshold and the second numeral value is smaller than the predetermined negative-feature threshold, define the common meaningful linguistic unit as the special feature point.

Certain aspects of the present disclosure are directed to a product special feature point generation method, which includes: receiving, by one or more first computing devices, a piece of positive review information related to a product and a piece of negative review information related to the product inputted at the one or more first computing devices by at least one user or through at least one product review message from one or more second computing devices, wherein each of the first and second computing devices is a remote computing device or a client device communicable with the remote computing device; performing, by one or more semantics analysis modules of the one or more first computing devices, positive review semantics analysis on the positive review information and negative review semantics analysis on the negative review information; generating, by one or more feature point generation modules of one or more of the first and second computing devices, at least one positive feature point of the product based on the positive review semantics analysis and at least one negative feature point of the product based on the negative review semantics analysis; and generating, by the one or more feature point generation modules, at least one special feature point by merging the positive feature point and the negative feature point based on similarity therebetween.

In certain embodiments, the step of performing review semantics analysis includes: segmenting, by the one or more semantics analysis modules, text of the positive review information into semantically meaningful positive keywords, and text of the negative review information into semantically meaningful negative keywords; and assigning, by the one or more semantics analysis modules, at least two of the semantically meaningful positive keywords that have semantic overlapping into the same first semantic group, and at least two of the semantically meaningful negative keywords that have semantic overlapping into the same second semantic group.

In certain embodiments, the step of performing review semantics analysis includes: determining, by the one or more semantics analysis modules, the first semantic overlapping degree of the first semantic group, the second semantic overlapping degree of the second semantic group, the first semantic overlapping ratio of each of the at least two semantically meaningful positive keywords in the same first semantic group, and the second semantic overlapping ratio of each of the at least two semantically meaningful negative keywords in the same second semantic group.

In certain embodiments, the step of generating the positive and negative feature points includes: defining, by the one or more feature point generation modules, one of the semantically meaningful positive keywords in the same first semantic group that has a highest first semantic overlapping ratio among the first semantic overlapping ratios as the positive feature point, one of the semantically meaningful negative keywords in the same second semantic group that has a highest second semantic overlapping ratio among the second semantic overlapping ratios as the negative feature point, a first weighting value of the positive feature point as a sum of weighting values of the semantically meaningful positive keywords in the same first semantic group to which the positive feature point belongs, and a second weighting value of the negative feature point as a sum of weighting values of the semantically meaningful negative keywords in the same second semantic group to which the negative feature point belongs.

In certain embodiments, the step of generating the special feature point further includes: comparing, by one or more semantics analysis modules of one or more of the first and second computing devices, the positive feature point with the negative feature point; determining, by the one or more semantics analysis modules of one or more of the first and second computing devices, whether at least one common meaningful linguistic unit exists both in the positive and negative feature points based on the comparison; and in response to determining at least one common meaningful linguistic unit exists both in the positive and negative feature points, defining, by the one or more feature point generation modules, the common meaningful linguistic unit as the special feature point, and a weighting value of the special feature point as a sum of a first weighting value of the positive feature point and a second weighting value of the negative feature point.

In certain embodiments, the step of generating the special feature point further includes: generating, by the one or more feature point generation modules, a first numeral value according to a first weighting value of the positive feature point and a second weighting value of the negative feature point, and a second numeral value according to the first weighting value of the positive feature point and the second weighting value of the negative feature point; comparing, by one or more semantics analysis modules of one or more of the first and second computing devices, the positive feature point with the negative feature point; determining, by the one or more semantics analysis modules of one or more of the first and second computing devices, whether at least one common meaningful linguistic unit exists both in the positive and negative feature points based on the comparison; determining, by the one or more semantics analysis modules of one or more of the first and second computing devices, whether the common meaningful linguistic unit is the positive feature point or the negative feature point; in response to determining the common meaningful linguistic unit is the positive feature point or the negative feature point, defining, by the one or more feature point generation modules, the positive feature point or the negative feature point as the special feature point, and a weighting value of the special feature point as a sum of the first weighting value of the positive feature point and the second weighting value of the negative feature point; in response to determining the common meaningful linguistic unit is not the positive feature point and not the negative feature point, determining, by the one or more feature point generation modules, whether the first numeral value is greater than a predetermined positive-feature threshold, and whether the second numeral value is greater than a predetermined negative-feature threshold; in response to determining the first numeral value is greater than the predetermined positive-feature threshold, defining, by the one or more feature point generation modules, the positive feature point as the special feature point; in response to determining the second numeral value is greater than the predetermined negative-feature threshold, defining, by the one or more feature point generation modules, the negative feature point as the special feature point; and in response to determining the first numeral value is smaller than the predetermined positive-feature threshold and the second numeral value is smaller than the predetermined negative-feature threshold, defining, by the one or more feature point generation modules, the common meaningful linguistic unit as the special feature point.

In certain embodiments, the step of generating the special feature point includes: generating, by the one or more feature point generation modules, a first numeral value according to a first weighting value of the positive feature point and a second weighting value of the negative feature point, and a second numeral value according to the first weighting value of the positive feature point and the second weighting value of the negative feature point; comparing, by one or more semantics analysis modules of one or more of the first and second computing devices, the positive feature point with the negative feature point; determining, by the one or more semantics analysis modules of one or more of the first and second computing devices, whether at least one common meaningful linguistic unit exists both in the positive and negative feature points based on the comparison; determining, by the one or more semantics analysis modules of one or more of the first and second computing devices, whether the common meaningful linguistic unit is the positive feature point or the negative feature point; in response to determining the common meaningful linguistic unit is the positive feature point or the negative feature point, defining, by the one or more feature point generation modules, the positive feature point or the negative feature point as the special feature point, and a weighting value of the special feature point as a sum of the first weighting value of the positive feature point and the second weighting value of the negative feature point; in response to determining no common meaningful linguistic unit exists both in the positive feature point and the negative feature point, determining, by the one or more semantics analysis modules of one or more of the first and second computing devices, whether at least one first linguistic unit in the positive feature point and at least one second linguistic unit in the negative feature point are semantically similar linguistic units; in response to determining the first and second linguistic units are semantically similar linguistic units, designating, by the one or more semantics analysis modules of one or more of the first and second computing devices, one of the first and second linguistic units as the common meaningful linguistic unit, and determining, by the one or more feature point generation modules, whether the first numeral value is greater than a predetermined positive-feature threshold and whether the second numeral value is greater than a predetermined negative-feature threshold; in response to determining the first numeral value is greater than the predetermined positive-feature threshold, defining, by the one or more feature point generation modules, the positive feature point as the special feature point; in response to determining the second numeral value is greater than the predetermined negative-feature threshold, defining, by the one or more feature point generation modules, the negative feature point as the special feature point; and in response to determining the first numeral value is smaller than the predetermined positive-feature threshold and the second numeral value is smaller than the predetermined negative-feature threshold, defining, by the one or more feature point generation modules, the common meaningful linguistic unit as the special feature point.

Certain aspects of the present disclosure are directed to a non-transitory computer readable medium storing computer executable code. The computer executable code, when executed at one or more processors of one or more of a remote computing device and at least one client device communicable with the remote computing device, can receive a piece of positive review information related to a product and a piece of negative review information related to the product through at least one product review message or inputted at the one or more of the remote computing device and the at least one client device by at least one user; perform positive review semantics analysis on the positive review information, and negative review semantics analysis on the negative review information; generate at least one positive feature point of the product based on the positive review semantics analysis, and at least one negative feature point of the product based on the negative review semantics analysis; and generate at least one special feature point by merging the positive and negative feature points based on similarity therebetween.

In certain embodiments, the computer executable code, when executed at the one or more processors, can segment text of the positive review information into semantically meaningful positive keywords, and text of the negative review information into semantically meaningful negative keywords; and assign at least two of the semantically meaningful positive keywords that have semantic overlapping into the same first semantic group, and at least two of the semantically meaningful negative keywords that have semantic overlapping into the same second semantic group.

In certain embodiments, the computer executable code, when executed at the one or more processors, can determine the first semantic overlapping degree of the first semantic group, the second semantic overlapping degree of the second semantic group, the first semantic overlapping ratio of each of the at least two semantically meaningful positive keywords in the same first semantic group, and the second semantic overlapping ratio of each of the at least two semantically meaningful negative keywords in the same second semantic group.

In certain embodiments, the computer executable code, when executed at the one or more processors, can define one of the semantically meaningful positive keywords in the same first semantic group that has a highest first semantic overlapping ratio among the first semantic overlapping ratios as the positive feature point, one of the semantically meaningful negative keywords in the same second semantic group that has a highest second semantic overlapping ratio among the second semantic overlapping ratios as the negative feature point, the first weighting value of the positive feature point as a sum of weighting values of the semantically meaningful positive keywords in the same first semantic group to which the positive feature point belongs, and the second weighting value of the negative feature point as a sum of weighting values of the semantically meaningful negative keywords in the same second semantic group to which the negative feature point belongs.

In certain embodiments, the computer executable code, when executed at the one or more processors, can compare the positive feature point with the negative feature point; determine whether at least one common meaningful linguistic unit exists both in the positive and negative feature points based on the comparison; and in response to determining at least one common meaningful linguistic unit exists both in the positive and negative feature points, define the common meaningful linguistic unit as the special feature point, and a weighting value of the special feature point as a sum of a first weighting value of the positive feature point and a second weighting value of the negative feature point.

In certain embodiments, the computer executable code, when executed at the one or more processors, can generate a first numeral value according to a first weighting value of the positive feature point and a second weighting value of the negative feature point, and a second numeral value according to the first weighting value of the positive feature point and the second weighting value of the negative feature point; compare the positive feature point with the negative feature point; determine whether at least one common meaningful linguistic unit exists both in the positive and negative feature points based on the comparison; determine whether the common meaningful linguistic unit is the positive feature point or the negative feature point; in response to determining the common meaningful linguistic unit is the positive feature point or the negative feature point, define the positive feature point or the negative feature point as the special feature point, and a weighting value of the special feature point as a sum of the first weighting value of the positive feature point and the second weighting value of the negative feature point; in response to determining the common meaningful linguistic unit is not a positive feature point and not a negative feature point, determine whether the first numeral value is greater than a predetermined positive-feature threshold, and whether the second numeral value is greater than a predetermined negative-feature threshold; in response to determining the first numeral value is greater than the predetermined positive-feature threshold, define the positive feature point as the special feature point; in response to determining the second numeral value is greater than the predetermined negative-feature threshold, define the negative feature point as the special feature point; and in response to determining the first numeral value is smaller than the predetermined positive-feature threshold and the second numeral value is smaller than the predetermined negative-feature threshold, define the common meaningful linguistic unit as the special feature point.

This and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a various opinion evaluation system according to the present disclosure.

FIG. 2 is a schematic view of a remote computing device according to the present disclosure.

FIG. 3 is a schematic diagram showing generation of positive, negative and special feature points based on positive and negative keywords by the special feature generation algorithm (SFG ALG) according to the present disclosure.

FIG. 4 is a schematic diagram showing the relationship among positive, negative and special features according to the present disclosure.

FIGS. 5 and 6 are schematic diagrams of review pages on a product review website according to the present disclosure.

FIGS. 7A and 7B are schematic diagrams showing positive and negative key arrays and keywords generated from review titles and bodies according to the present disclosure.

FIG. 8 is a flowchart showing the processes of special feature point generation according to the present disclosure.

FIGS. 9A and 9B are schematic diagrams showing the relationship among positive, negative and special keywords and feature points and positive and negative reviews according to the present disclosure.

FIG. 10 is a schematic diagram showing the merge of keywords to generate a feature point according to the present disclosure.

FIG. 11 is a schematic diagram showing the merge of feature points to generate a special feature points according to the present disclosure.

FIGS. 12A-12C are schematic diagrams of exemplary merged positive, negative and special feature points in the Pros, Cons and Special Feature (SF) groups according to the present disclosure.

FIG. 13 is a schematic diagram of a product main page on the product review website according to the present disclosure.

FIG. 14 is a schematic diagram showing determination of a special feature point based on a balance curve algorithm according to the present disclosure.

FIGS. 15-16D are flowcharts of special feature point generation according to the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. The meaning of the term “one or more” includes singular reference and plural reference, for example, being used to refer to involvement of a single item/component/part and of a plurality of items/components/parts, notwithstanding the term is used with a singular or plural noun or a singular or plural verb. Titles or subtitles can be used herein for the convenience of a reader, which shall have no influence on the scope of the present disclosure. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various items, components, parts or the like, which are for distinguishing one item/component/part from another one only, and are not intended to, nor should be construed to impose any substantive limitations on the items, components, parts or the like, or be relevant to the sequence in which the items/components/parts are to be presented, placed, assembled or disposed in practical application.

As used herein, the term “module” generally refers to a self-contained or non-self-contained functional component which generates data or any other sort of output, based on data or any other sort of input received or retrieved by the module, to perform certain specific tasks, and can broadly be, partly or wholly, or included in, at least one software component, at least one hardware component, and/or at least one firmware component, or any combination of the above. A module may include one or plural software applications and/or programs executable by at least one processor of a computing device, and when executed by said processor, cause the computing device to perform specific and/or general tasks. A module may be included in one or plural software applications and/or programs, and/or be part of, or include, one or more hardware components that provide certain desired functionality, such as at least one electronic circuit, at least one combinational logic circuit, at least one field programmable gate array (FPGA), at least one Application Specific Integrated Circuit (ASIC), at least one non-volatile or volatile memory storing code executable by said processor, and/or at least one processor configured to execute code, or any combination of the above. A module can be included in or constitute, solely or collectively with other module(s) and/or component(s) referred supra, a special-purpose computing device configured to perform certain specific tasks or a general-purpose computing device. Modules described or depicted separately in the present disclosure may be portions of the same module, the same software application and/or program, the same hardware and/or firmware component, and/or any combination of the above, and a module may include a plurality of modules that can otherwise be described or depicted separately while still falling within the scope of the present disclosure.

As used herein, the term “code” generally refers to a computer-readable communication form that serves to mediate communication with a computer and implement certain desired functionality through the computer. Code can be programs, instructions, microcode, routines, functions, procedures, classes, objects, algorithms, stored data, or any combination of the above, etc. Code can be implemented as software. In addition, code can, partly or wholly, constitute, or be included in, one or more modules that can be stored on one or more storage media and executed by one or more processors. Code can include computer programs having instructions executable by a processor and being stored on a non-transitory tangible computer readable medium.

As used herein, the term “computer-readable medium” generally refers to any available form of medium that can store or carry computer-executable instructions or data structures. The computer-readable medium can be accessible by a general-purpose or special-purpose computer, and be downloadable through communication networks. A non-transitory tangible computer readable medium may exemplarily be or include one or more flash memory storages, such as one or more solid-state drives (SSDs), one or more NAND flashes, etc.; one or more read-only memories (ROMs), such as one or more erasable programmable ROMs (EPROM)s, one or more electrically erasable programmable ROMs (EEPROMs), etc.; one or more ferroelectric random-access memories (RAMs); one or more hard disk drives (HDDs); one or more memory cards; one or more USB drives; caches; one or more floppy disks; one or more optical disk drives; a portion or a combination of the above; or any other suitable data storage device that provides the described functionality.

As used herein, the term “semantically meaningful keyword” generally refers to a keyword that has semantic meaning either by the keyword itself or in view of the context of the text or non-text that contains the keyword, and may be a semantically meaningful positive keyword (hereinafter, “positive keyword”) or semantically meaningful negative keyword (hereinafter, “negative keyword”). A keyword generally refers to a linguistic unit whose composition may include one or more semantic units, one or more lexical units, one or more words, one or more characters, one or more compound words, one or more compound characters, one or more complex words, one or more pictograms, one or more simple ideograms, one or more compound ideographs, one or more rebus characters, one or more phono-semantic compound characters, one or more sentences or a fraction thereof, one or more clause or a fraction thereof, one or more idioms, one or more phrases, one or more sayings, and/or one or more collocations, and/or any combination of the above, etc.

As used herein, the term “common meaningful linguistic unit” generally refers to a linguistic unit that has semantic meaning and exists both in at least one positive feature point and at least one negative feature point. A common meaningful linguistic unit may be a part, or the entirety, of a positive or negative feature point, and/or a part, or the entirety, of a semantically meaningful keyword.

As used herein, the term “semantically similar linguistic units” generally refer to linguistic units in feature points that have semantic similarity, but are not entirely the same in their character composition or semantic meaning. Semantically similar linguistic units may exemplarily be hypernyms, hyponyms, synonyms, etc. to each other.

Computer components applied in the systems, apparatuses, methods and/or articles according to the present disclosure can include, and/or be implemented as, software, hardware and/or firmware components. Such systems, apparatuses, methods and/or articles can generally be implemented as and/or in a special-purpose or general-purpose computer comprising a variety of software and/or hardware components and/or modules that are detailed in the present disclosure, and can be implemented by one or more computer programs and be executed by one or more processors.

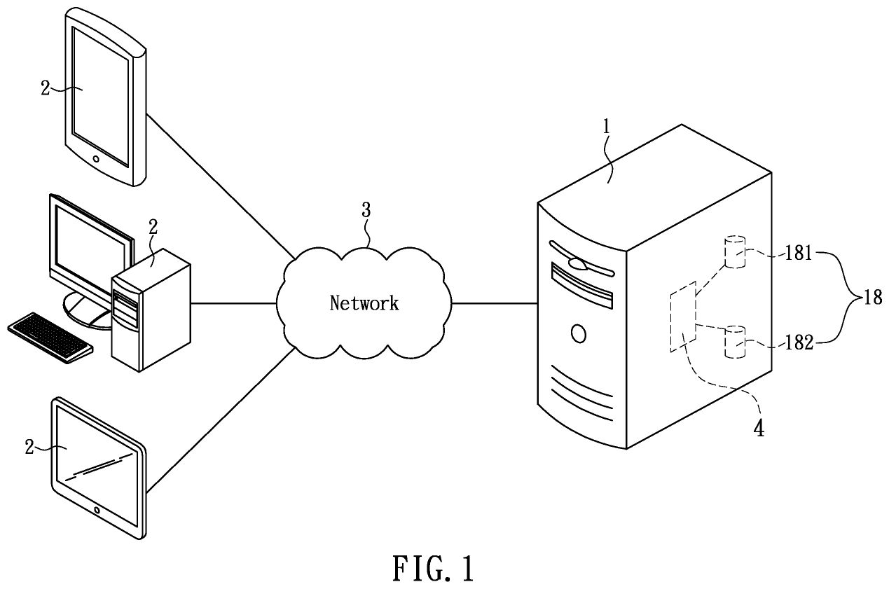

Certain aspects of the present disclosure are directed to a various opinion evaluation system that outputs at least one special feature point according to the review content inputted by at least one user on a product review website. FIG. 1 schematically depicts an exemplary various opinion evaluation system according to certain embodiments of the present disclosure. The various opinion evaluation system includes one or more computing devices that each can either be a remote computing device 1 or a client device 2 that is connectable to the remote computing device 1. In certain embodiments, the various opinion evaluation system is connectable to a plurality of client devices, and/or includes a plurality of client devices interconnectable with each other, through one or more networks. In certain embodiments, the remote computing device 1 includes pieces of computer hardware and/or computer software or programs that can work individually as part of, or collectively as, a web server that communicates and interchanges data and messages with at least one client device 2 through a network 3. The remote computing device 1 can store, maintain, and/or load computer software or programs that render the remote computing device 1 a web server for a product review website 4, for example, computer software or programs which enable communication between the remote computing device 1 and the client device(s) 2 under application layer protocols such as the Hypertext Transfer Protocol (HTTP) and via Uniform Resource Identifiers (URIs) such as Uniform Resource Locators (URLs); component files of the product review website 4, such as image files, multi-media files, HTML documents, style sheets such as cascading style sheets, JavaScript and/or other programming language files (for non-limiting example, files developed through Flutter, NativeScript, React Native, Xamarin, Titanium SDK and/or any other application development kit or framework), etc.; and a user data collection 181 storing the information of the users of the product review website 4, and a product data collection 182 storing the information of the product(s) available on the product review website 4. However, the present disclosure is not limited thereto. In certain embodiments, the component files and/or the data collection(s) of the product review website 4 can be stored independent from and external to the remote computing device 1, and is accessible and retrievable by the remote computing device 1. In certain embodiments, the remote computing device 1 may be configured to allow a user to access therethrough the webpages, and content thereof, of the product review website 4, and the webpages, and content thereof, of the product review website 4 can be displayed to the user through the remote computing device 1. The remote computing device 1 may be configured to allow a user to input information thereto, such as through an input/output (I/O) interface, and therefore to the product review website 4, and transmit the information inputted by the user to the product review website 4. The remote computing device 1 can be installed with at least one web browser application program such as Google Chrome, Microsoft Edge, Mozilla Firefox, Internet Explorer, Opera, etc. or an application program that allows a user to access and, if membership mandated service mechanism is in place, log in the product review website 4 to read, write and browse through the product reviews and/or access any other features, functions and services of the product review website 4, and displays the webpage(s) and content or file(s) associated therewith that is requested or inputted by the user through the application program. In certain embodiments, a remote computing device 1 may be a blade server, a rack server, a tower server, a laptop, a desktop computer, a tablet computer, a smartphone, etc. In certain embodiments, the network 3 may be a wired or wireless network. Various examples of the network 3 may include, but is not limited to, the Internet, a wide area network (WAN), a local area network (LAN), an Internet area network (IAN), etc. In certain embodiments, the various opinion evaluation system can include at least one client device 2, or in addition to the remote computing device 1, further include at least one client device 2, the network 3, and/or the product review website 4.

The product review website 4 includes a series of web pages that, along with the content, documents and/or files associated therewith and provided thereby, provide users with functions and abilities of leaving, reading, browsing through, and/or exchanging reviews on products. A product is defined in the present disclosure as a piece of tangible goods or an intangible service. In certain embodiments, the product review website 4 displays the feature point(s) of the product(s) listed thereon by the users, each of the reviews can be assigned with and related to at least one feature point related to the content of the review and, partly or wholly, the same as or different from the feature point(s) assigned with and related to another review. Since a user of the product review website 4 may leave as well as read reviews on particular goods or services on the product review website 4, such a user acts both as a reader of and a writer for the product review website 4.

The client device 2 is a computing device through which a user can access the webpages, and content thereof, of the product review website 4 and the webpages, and content thereof, of the product review website 4 can be displayed to the user. The client device 2 is configured to allow a user to input information thereto, such as through an input/output (I/O) interface, connect to the remote computing device 1 and therefore to the product review website 4, and transmit the information inputted by the user to the product review web site 4 and the remote computing device 1. The client device 2 can be installed with at least one web browser application program such as Google Chrome, Microsoft Edge, Mozilla Firefox, Internet Explorer, Opera, etc. or an application program that allows a user to access and, if membership mandated service mechanism is in place, log in the product review website 4 to read, write and browse through the product reviews and/or access any other features, functions and services of the product review website 4, and displays the webpage(s) and content or file(s) associated therewith that is requested or inputted by the user through the application program. In certain embodiments, multiple client devices 2 can be communicatively interconnected with the remote computing device 1 and/or with one another at the same time or different times, and the same or different users can read, write and browse through reviews at the same time or different times on multiple client devices 2. In certain embodiments, a client device 2 may be a laptop, desktop or tablet computer, smartphone, etc.

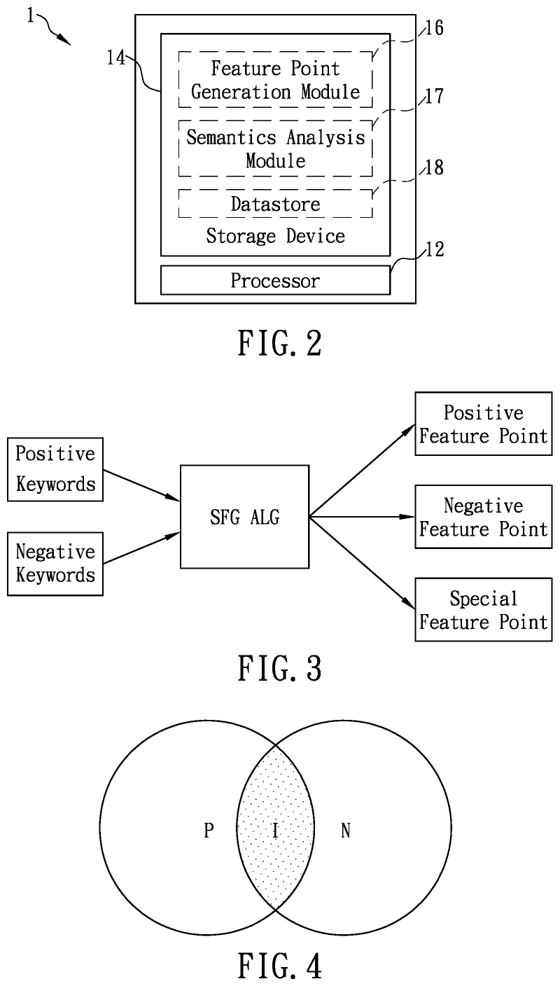

FIG. 2 schematically depicts an exemplary remote computing device 1 according to certain embodiments of the present disclosure. The remote computing device 1 includes a processor 12, a storage device 14, and other hardware and software components, and is configured to perform tasks including: receiving from a client device 2 information inputted by the user; processing, and generating at least one feature point from, the received information; maintaining and/or updating the content of the product review website 4 based on the information inputted by the user and the generated feature point(s); sending the maintained or updated content to the client device 2, for example, information that is displayable on a web browser in a form of a webpage or a portion thereof that shows updated content according to the inputted information; upon receiving a request by the user for information on the product review website 4 from the client device 2, such as a particular webpage, document or file, sending the requested information to the client device 2; receiving one or more log-in requests and user identification information by one or more users from one or more client devices 2 at the same time or different times; authenticating the identit(ies) of the requesting user(s) at the same time or different times; upon determining the identit(ies) of the requesting user(s) is authenticated, allowing the log-in request(s); sending information that is of an authorization level that is requested by the authenticated user(s) upon a request by the authenticated user(s); storing information sent by the authenticated user from the client device 2 in the datastore(s) of the remote computing device 1; and upon determining the identit(ies) of the requesting user(s) is not authenticated, denying the log-in request(s) and not sending information that is of an authorization level to the unauthenticated user. However, the present disclosure is not limited thereto. In certain embodiments, part of the tasks referred supra, such as identity authentication, can be performed by another computing device that is independent from, external to, and connectable and communicable with the remote computing device 1. Further, the remote computing device 1 may also include other hardware components and software components (not shown) to perform afore-mentioned or other tasks. Various examples thereof may include, but not limited to, interfaces, buses, memories, peripheral devices, Input/Output (I/O) modules, which can serve to receive input or instruction from a user of the remote computing device 1, and/or send and receive messages to and from, if any, other computing devices of the various opinion evaluation system, such as at least one client device 2, etc.

The processor 12 is configured to interpret and/or execute computer-readable instructions, and process various tasks and operation of the remote computing device 1. In certain embodiments, the processor 12 may be, but not limited to, a microprocessor, a microcontroller, a central processing unit (CPU), a graphics processing unit (GPU), an ASIC, a FPGA, a portion or a combination of one or more of the above, or any other suitable hardware component that provides the described functionality. The processor 12 can receive and execute computer-readable instructions from the various module(s) of the remote computing device 1. In certain embodiments, multiple processors 12 are included in and process the tasks and operation of the remote computing device 1, and the number of the processor(s) may vary to suit the practical needs of the remote computing device 1. The storage device 14 is a data storage device or media configured to store data and/or computer-readable instructions for executing, at the processor 12, the functionality of the module(s) and/or application(s) of the remote computing device 1. In certain embodiments, a feature point generation module 16, a semantics analysis module 17, at least one datastore 18, and/or other application(s), module(s) and/or datastore(s) of the remote computing device 1 can be stored in and/or loaded by the storage device 14, and be accessed, retrieved and/or executed by the processor 12. In certain embodiments, the storage device 14 may include a non-volatile memory including at least one flash memory storage, such as a SSD, a NAND flash, etc., at least one ROM, such as an EPROM, an EEPROM, etc., at least one ferroelectric RAM, at least one HDD, at least one memory card, at least one USB drive, caches, at least one floppy disk, at least one optical disk drives, a portion or a combination of one or more of the above, or any other suitable data storage device that provides the described functionality. In certain embodiments, the remote computing device 1 may have a plurality of storage devices 14 whose types or forms are identical or different partly or entirely. In certain embodiments, the storage device 14 includes one or more volatile memories, such as one or more RAMs, and/or a volatile memory array, and the number of the volatile memories may vary to suit the practical needs of the remote computing device 1.

The remote computing device 1 can be stored with user data collection 181 and product data collection 182 of the product review website 4 in the same or different datastores 18. The data collections 181, 182 can be structured as, and/or retrieved as in, the same or different databases; The remote computing device 1 is configured to retrieve data from the user data collection 181 and the product data collection 182; generate and/or update the component files of, and therefore the content displayed on, the product review website 4 according to the retrieved data from the user data collection 181 and the product data collection 182; and update the user data collection 181 and the product data collection 182 with information inputted by a user in and sent from a client device 2 or in the remote computing device 1. The user data collection 181 includes multiple pieces of user data. Each piece of user data includes a user identification code and user personal information associated with the user identification code, such as user name, nickname, gender, address, shopping record, etc. The user identification code uniquely corresponds to a particular user of the product review website 4, and represents the identity of the user that corresponds to the piece of user data. That is, the user identification codes of the multiple pieces of user data are different from each other. In certain embodiments, the user identification codes may be based on user account, government-assigned identity number, machine code, mobile phone number, and/or international mobile equipment identity (IMEI), etc., or be generated by the remote computing device 1 through a random number generator or other means. The product data collection 182 includes multiple pieces of product data. Each piece of product data corresponds to a piece of goods or a service, and includes product basic information such as the name, price, production date, launch date, etc. of the goods or service, positive review information and negative review information of the goods or service, keyword information and feature point information of the goods or service. The positive review information can include review content inputted by the user(s) of the product review website 4 in the positive review field(s) and/or section(s) thereof that corresponds to the goods or service, such as that reflecting the positive mental impressions and positive opinions on, and written by the users of, such a piece of goods or a service, and in certain embodiments includes, but not limited to, respective review titles, review bodies and other review information of positive reviews, and the user identities, that is, the author identities, of the positive reviews. The negative review information can include review content inputted by the user(s) of the product review website 4 in the negative review field(s) and/or section(s) thereof that corresponds to the goods or service, such as that reflecting the negative mental impressions and negative opinions on, and are written by the users of, such a piece of goods or a service, and in certain embodiments includes, but not limited to, respective review titles, review bodies and other review information of the negative reviews, and the user identities, that is, the author identities, of the negative reviews. The keyword information can include the semantically meaningful keyword(s) corresponding to the goods or service that is generated through semantics analysis according to the positive review information and/or negative review information, review identifier information indicating the identit(ies) of the review(s) labeled with the semantically meaningful keyword(s), and the attribute(s) of the semantically meaningful keyword(s) being positive or negative in the reviews labeled with the semantically meaningful keyword(s). The feature point information can include the feature point(s) corresponding to the goods or service that is generated, and can be assigned with an attribute being positive, negative or special, by the remote computing device 1 according to the keyword information; and review identifier information indicating the identities of the reviews labeled with the feature point(s). In certain embodiments, an attribute of a feature point that is labeled as special is generated in response to the remote computing device 1 or a client device 2 determining a feature point is a special feature point. In certain embodiments, the user data collection 181, the product data collection 182 and the component files are stored in the same remote computing device 1 that includes the hardware and software components that render the remote computing device 1 a web server for the product review website 4. However, the present disclosure is not limited thereto. In certain embodiments, at least one of the user data collection 181, the product data collection 182, and the web server for the product review website is stored in a device different from the remote computing device 1. In certain embodiments, the user and product data collection 181, 182 are integrated into one data collection and function as a single database.

In certain embodiments, the storage device of at least one client device 2 can store data and/or computer-readable instructions for executing, at a processor of the client device 2, the functionality of the module(s) and/or application(s) of the client device 2, for example, storing, all or part of, a feature point generation module, a semantics analysis module, and at least one datastore that can include at least one of user data collection and product data collection. The feature point generation module, semantics analysis module, datastore, user data collection and product data collection of the client device 2 can be the same respectively as, and respectively perform the same tasks and/or provide the same functions as that by the feature point generation module 16, semantics analysis module 17, datastore 18, user data collection 181 and product data collection 182 of the remote computing device 1. For example, the feature point generation module and semantics analysis module of a client device 2 can respectively perform the same tasks of the feature point generation module 16 and semantics analysis module 17 of the remote computing device 1, including, but not limited to, positive and negative keywords generation, keyword merge, positive and negative feature point generation, feature point merge, special feature point generation, etc. In certain embodiments, the tasks or functions described in the present disclosure, supra and infra, as being performed by or within the capacity of the feature point generation module 16 and semantics analysis module 17 of the remote computing device 1 respectively fall within the scopes of tasks and capability of the feature point generation module and semantics analysis module of a client device 2. Accordingly, the feature point generation module and the semantics analysis module of a client device 2 can share and perform, part or all of, the tasks of the feature point generation module 16 and semantics analysis module 17 of the remote computing device 1, and the remote computing device 1 can receive the keyword(s), feature point(s) and/or other data generated by a client device 2 through the network 3 to update the content of the product review website 4 and the datastore 18. In certain embodiments, at least one of the client devices 2 has a feature point generation module and a semantics analysis module, and the feature point generation module 16 and semantics analysis module 17 are omitted from the remote computing device 1. In certain embodiments, each of at least two client devices 2 has at least one of the feature point generation module and a semantics analysis module, and based on the feature point generation module(s) and the semantics analysis module(s), the at least two client devices 2 can collectively perform part or all of the tasks referred to supra performed by the remote computing device 1 by communicating with and exchanging data between each other through a network that may be independent from or be the network 3. For example, one of the client devices 2 can receive a product review message from another client device 2, and performs tasks the same as that by the remote computing device 1, including, but not limited to, retrieving data and updating its datastore based on the product review message, performing a subsequent procedure in response to a procedure performed by another client device 2, etc., including part or all of the procedures referred to infra in the present disclosure. A client device 2 may also include other hardware components and software components (not shown) to perform afore-mentioned or other tasks. Various examples thereof may include, but not limited to, interfaces, buses, memories, peripheral devices, Input/Output (I/O) modules, which can serve to receive input or instruction from a user of the client device 2, and/or send and receive messages to and from, if any, other computing devices of the various opinion evaluation system, such as the remote computing device 1, etc.

Referring to FIG. 3, the various opinion evaluation system according to the present disclosure can, based on positive and negative keywords generated from the reviews of a piece of goods or service on the product review website 4, generate feature points of the goods or service, in particular, at least one special feature point, through a series of functions and/or algorithms detailed infra that may be referred to collectively in the present disclosure as the SFG ALG. Referring to FIG. 4, a special feature point of a product according to the present disclosure can be defined as a product feature that may be considered by certain users to be positive or advantageous, and at the same time also be considered by certain other users as negative or disadvantageous. For example, a first user may, based on his or her inner opinion, leave on the product review website 4 a positive review on a particular product that encompasses a first group of features P of the product, and a second user may, also based on his or her inner opinion, leave on the product review website 4 a negative review on the particular product that encompasses a second group of features N of the product. The first group and second group of features may intersect, that is, overlap, each other wholly or partly by an intersection portion, such as the portion I exemplarily shown in FIG. 4. Such an intersection portion I of the product features, that is, the intersection of the first and second groups P, N of the product features, in numerous instances, may encompass the product feature(s) that reflects more about, and is more subjected to, the subjective interpretation of the users toward the goods or service, and less about the objective properties thereof, and is accordingly particularly identified as the special feature point(s) of the goods or service in the present disclosure. In certain embodiments, a special feature point may be a semantically meaningful keyword or a meaningful linguistic unit identified with an attribute labeled as positive in a first review, and with an attribute labeled as negative in a second review, that is, a common semantically meaningful keyword or common meaningful linguistic unit of the first and second reviews.

For example, assuming that an exemplary controversial public figure is named John Smith; positive reviews, and favorable features contained therein, of a restaurant on the product review website 4 from certain users include “great soup”, “tasty meat”, “recommended by John Smith”, etc.; and negative reviews, and unfavorable features contained therein, of the restaurant on the product review website 4 include “missing invoices”, “frequent waiting in a long line”, “pricy”, “recommended by John Smith”. Since John Smith is controversial, certain users may treat recommendation by John Smith as a positive feature, while certain other users may treat such recommendation as a negative feature. Being presented both in the positive and negative reviews and features, the feature “recommended by John Smith” will be defined as a special feature point of the restaurant by the various opinion evaluation system according to the present disclosure, for example, by the remote computing device 1 and/or at least one client device 2. For another example, positive reviews, and favorable features contained therein, of a smartphone on the product review website 4 from certain users may include “photos taken are lovely”, “strong endurability”, “convenient facial recognition system”, etc.; and negative reviews, and unfavorable features contained therein, of the smartphone on the product review website 4 may include “pricy”, “LCD display”, “no multi-camera”, “difficult facial recognition system”, etc. Being presented both in the positive and negative reviews and features, the feature “facial recognition system” will be defined as a special feature point of the smartphone by the various opinion evaluation system according to the present disclosure.

Identifying special feature points helps identify user opinions of a more subjective character or product features that are more prone to be subjected to subjective interpretation from the opinions that are less subjective, that is, more objective, or from product features less prone to be subjected to subjective interpretation or of a more objective character. Take a food product for example, assuming that a feature “spicy” may be considered as positive or advantageous by users who favor spicy food, and negative or disadvantageous by users who do not, such a feature can be determined by the various opinion evaluation system, for example, by the remote computing device 1 and/or at least one client device 2, as a special feature, and therefore recognized as a more subjective feature that reflects also the subjective opinion of the users instead of mere objective factual features, based on its appearance both in the positive and negative reviews according to the present disclosure. In contrast, assuming that a feature “lots of filling” of the food product appears only in the positive reviews, such a feature is not determined by the various opinion evaluation system as a special feature, and is therefore recognized as a more objective feature whose objectiveness is thereby also recognized as well-known to and approved by the consumers according to the present disclosure. Accordingly, for a user of the various opinion review system according to the present disclosure, his or her effort and time in browsing through and reading reviews related more to objective factual product features can be lessened, and can be focused on the special features that are controversial of a piece of goods or service, such as the afore-referenced exemplary “spicy” feature of the food product.

Further, identifying special feature points helps avoid dilution of the weighting value, statistical or non-statistical, of a special feature point of a more subjective character, that is, from being decreased, as can be caused by its dispersion both in the positive or Pros reviews and in the negative or Cons reviews. For example, a weighting of a feature point in the positive or Pros aspect may be based on only sixty occurrences in the positive or Pros reviews, and a weighting of the feature point in the negative or Cons aspect may be based on only forty occurrences in the negative or Cons reviews, while the weighting of the feature point that really shows the impact of the feature point should be based on a total of one hundred of occurrences in all reviews, that is, the sum of the sixty occurrences in the positive or Pros reviews and forty occurrences in the negative or Cons reviews.

Further, identifying special feature points also help raise brand or product awareness and facilitate customer group segregation. First, as referred supra, a special feature point represents an intersection of positive and negative features where consumers' product perception differs and collides, that is, where conflict points lay and topics can be created. For a relatively mature goods or service market, products in the same category have high homogeneity, and it is more difficult for a product provider, among its peers that sell similar goods or offers similar services, to win the favor of consumers. For a market where a particular piece of goods or service is not yet popularized, consumers have low awareness of or low concern for such a product. It is therefore clear that topicality is required for a product to either make a breakthrough in a mature market or have higher awareness in an emerging market. Once the product acquires its topicality, popularity ensues, which increases the trading volume of the product. Accordingly, by identifying the special feature point(s) of a product, topical conflict points, that is, the intersection of the positive and negative reviews of the product, can be located accordingly, which can increase the click through rate of the product, serve as a selling point for marketing, and discover the keyword(s) that can ignite a trending earlier. More specifically, referring again to the restaurant example supra, the exemplary special feature point “recommended by John Smith” of the restaurant would have strong connection to the supposingly contradictory social cognition of the exemplary controversial public figure, and is accordingly different from features that may ordinarily be comparatively quantitative, such as price, food freshness, etc. Therefore, such a special feature point, when applied in marketing, has a good chance to detonate discussions and social trends for the restaurant. On the other hand, referring again to the smartphone example supra, the exemplary special feature point “facial recognition system” represents a relatively new technique feature compared to other products in the same category, and may serve as a selling point of the exemplary smartphone when applied in marketing. As a result of applying the special feature point(s) generated by the various opinion evaluation system according to the present disclosure in goods or service marketing and in creating topicality for the product associated therewith, the sight of the special feature point(s) on the product review website 4 that is generated based on the identified special feature(s), and of a more subjective character, can increase consumers' willingness to click on and read the product reviews. Should a consumer be discontent with the existing review(s) of a piece of goods or a service on the product review website 4, he or she may joint in as a new user/author of a new review of the product, and a user of an existing review of the product may edit the content of the review, or create a follow-on review in reply to the new review by the new user, therefore forming a positive feedback eco-chain/ecosystem that attracts new users to the various opinion evaluation system according to the present disclosure. Accordingly, the special feature point(s) also facilitates the expansion and enrichment of the content of the reviews of the products on the product review website 4, and helps marketing professionals to more precisely identify the connection point(s) between the user(s) having positive opinions on a product and the user(s) having negative opinions on the product.

Second, in a nowadays diverse society, it is common for people to have different, even opposite, preferences and beliefs about political and social issues, and even about the ways of providing, or quality or the content of, a product. Nevertheless, a product provider may not be capable of handling every dispute or conflict properly or in time. Since a special feature point according to certain embodiments of the present disclosure may generally refer to the intersection of the positive and negative product features based on user positive opinions and negative opinions, a user can swiftly grasp the gist of a product beforehand through the special feature point(s), that is, the overlapping portion of product features based on the positive and negative opinions on the product. For example, the exemplary special feature point “facial recognition system” may serve to help consumers not familiar with the exemplary smartphone to grasp the specialties of the product features thereof, and therefore to decide whether to endorse and/or pay for the product based on their preferences, which lowers the likelihood of disputes and conflicts.

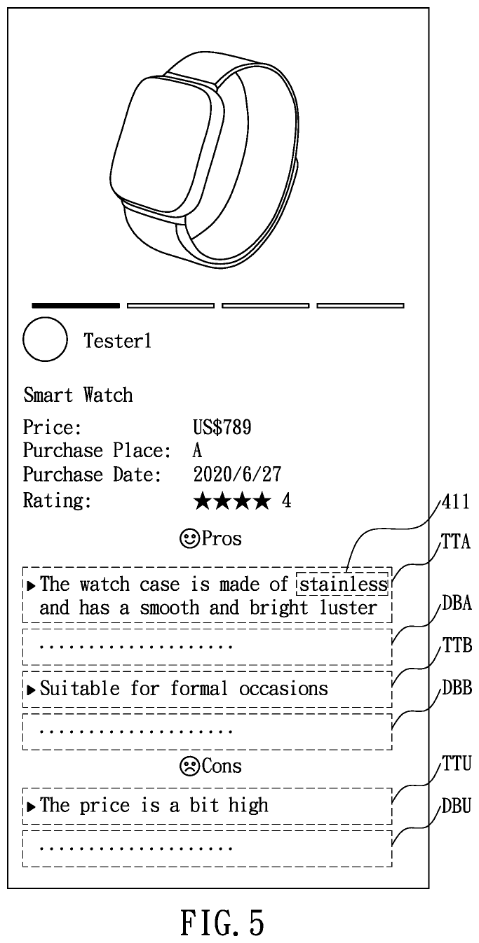

In certain embodiments, the remote computing device 1 is configured to log a user in the product review website 4; send information related to the content of the product review website 4 that is displayable through a browser application program on a client device 2 or the remote computing device 1 operated by the user in response to receiving a request by the user sent from the client device 2 or at the remote computing device 1, such that, for example, the user can browse through the webpages and reviews of the product review website 4; and receive from the client device 2 or at the remote computing device 1, and update the user data collection 181 and the product data collection 182 with, the information inputted by the user. The product review website 4 includes at least one review page configured to guide and allow a user to input, through a client device 2 or the remote computing device 1, product information for a piece of goods or a service, such as product name, price, purchase location, purchase date, product image or photo, etc.; user decisions on product attributes presented, for example, in a true-or-false, multiple-choice or other layouts, for example, whether recommendable to a friend; and detailed reviews and other product review information. In certain embodiments, the review page has positive review fields and negative review fields in which a user may fill in corresponding review contents based on his or her opinions on the goods or service. The review fields may include at least one of at least one review title field for being inputted with the title of a review, at least one review abstract field for being inputted with the abstract of a more detailed content of the review, and at least one review body field for being inputted with the detailed content of the review. FIGS. 5, 6 and 13 schematically show exemplary review pages, on which a user may read and/or input review information, and a product main page, which displays various information of a piece of goods or a service, of a smart watch product on the product review website 4 according to certain embodiments of the present disclosure. A review page may have a Pros section displaying positive opinions on the exemplary smart watch product that are inputted by one or more users, which may include positive review titles and positive review bodies. For example, a first positive review title may read “the watch case is made of stainless and has a smooth and bright luster”, and a second positive review title may read “suitable for formal occasions”, and each positive review title can be arranged adjacent to a positive review body that shows review content in more detail and related to the review title. Likewise, a review page may have a Cons section displaying negative opinions on the exemplary smart watch product that are inputted by one or more users, which may include negative review titles and negative review bodies. For example, a negative review title may read “the price is a bit high”, and is arranged adjacent to a negative review body that shows the review content in more detail and related to the negative review title. However, the present disclosure is not limited thereto, and in certain embodiments, at least one of the Pros and the Cons sections may have the review title(s) but not the review bod(ies). In certain embodiments, each of the Pros section and the Cons section may have at least one review title field for a user to input therein brief review text or the gist of a review, such as the text referred supra in the review titles, and at least one review body for a user to input therein review content in more detail and related to the review title. When a user finishes filling information, at a client device 2 or the remote computing device 1, in the fields in the Pros and/or Cons section, and decides to send the information to the product review website 4, that is, to be received at the remote computing device 1, the inputted information is converted into a product review message by the client device 2 or the remote computing device 1 through which the information is inputted, which includes the respective pieces of information inputted on the review page, for example, the product basic information including “smart watch”, the positive review information including all of the content of the Pros section, and the negative review information including all of the content of the Cons section. A product review message can contain information including the review title(s) and/or the review bod(ies) and indication of the correspondence between the review title(s) and the review bod(ies) in the Pros section and/or in the Cons section.

In certain embodiments, a product review message contains a user identification code, a piece of product identification information, at least one piece of positive review information, and at least one piece of negative review information. The user identification code in the product review message corresponds to one of the user identification codes in the user data collection 181, and the remote computing device 1 is configured to retrieve the matching piece of user data and the user information therein in the user data collection 181 according to the correspondence between the user identification code in the product review message and the matching piece of user data. The product identification information corresponds to a piece of product data in the product data collection 182, and may include product name and/or product unique identification code, etc., and the remote computing device 1 is configured to retrieve a matching piece of product data in the product data collection 182 based on the correspondence between the product identification information in the product review message and the product basic information in the piece of product data. However, the present disclosure is not limited thereto, and a product review message may include, partly or wholly, other information inputted by the user on the product review website 4. In certain embodiments, a product review message may include a piece of positive review information but not a piece of negative review information, for example, the value of a negative review information field of a product review message is null, if a user does not input information in the negative review field shown on a review page of the product review website 4. Likewise, a product review message may include a piece of negative review information but not a piece of positive review information, for example, the value of a positive review information field of the product review message is null, if a user does not input information in the positive review field shown on a review page of the product review website 4.

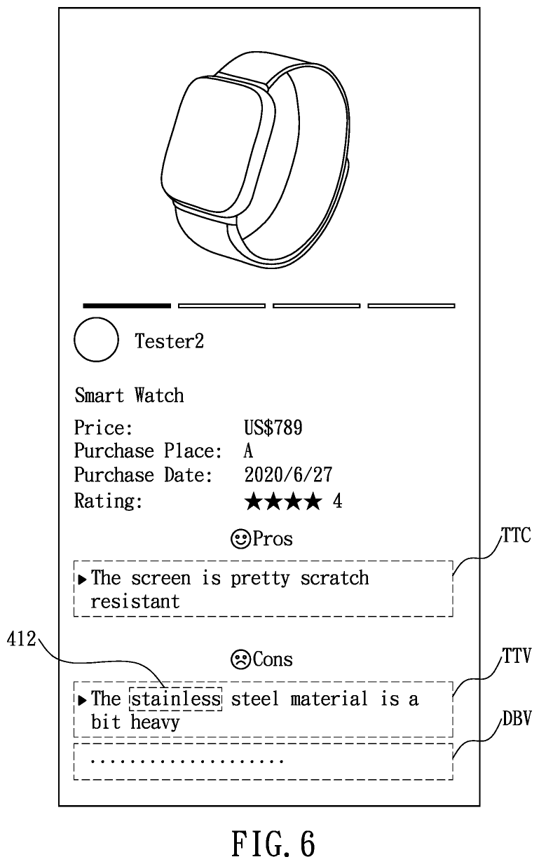

In certain embodiments, the information inputted by the user on the product review website 4, converted into a product review message by the client device 2, and sent by the client device 2 to the remote computing device 1, or inputted at the remote computing device 1, can be employed by the remote computing device 1 to generate positive and negative feature points. In certain embodiments, the information, for example, positive and/or negative review information or any that could present in a product review message as referred to supra, inputted by the user in a client device 2 or the remote computing device 1, whether on the product review website 4, or not on the product review website 4 but inputted in the client device 2 or the remote computing device 1 in an offline state with respect to the product review website 4, can be employed by the remote computing device 1 to generate positive and negative keywords and feature points, or by the client device 2 to generate positive and negative keywords and feature points through procedures and/or modules the same as or similar to those of the remote computing device 1 as described in the present disclosure, and whose description is therefore omitted herein for brevity. The remote computing device 1 is configured to receive a product review message which may be sent from a client device 2; extract the positive review information in the product review message, for example, the linguistic/text information in the positive review title(s) and/or the positive review bod(ies) and the respective correspondence information therebetween; update the positive review information of a corresponding piece of product data in the product data collection 182 according to the positive review information in the product review message; extract the negative review information in the product review message, for example, the linguistic/text information in the negative review title(s) and/or the negative review bod(ies) and the respective correspondence information therebetween, and update the negative review information of a corresponding piece of product data in the product data collection 182 according to the negative review information in the product review message. For example, referring again to the exemplary smart watch product described supra and FIGS. 5 and 6, for facilitating understanding only, certain review titles on a review page by a user Tester1 may exemplarily be named and understood respectively as, but not limited to, TTA, TTB and TTU, and the review bodies respectively as DBA, DBB and DBU, by or in the remote computing device 1 and the product review message, and correspondence relationship between TTA and DBA, between TTB and DBB, and between TTU and DBU can be indicated in the product review message, and can be indicated in the product data collection 182 by updating the product data collection 182 according to the indications in the product review message; and likewise, certain review titles on a review page by a user Tester2 may exemplarily be named and understood respectively as, but not limited to, TTC and TTV, and the review page can have or does not have review bodies that correspond to review titles TTC and TTV, respectively. For example, the review page in FIG. 6 shows the review body DBV corresponding to the review title TTV without showing a review body corresponding to the review title TTC.

At least one of the remote computing device 1 and at least one client device 2 has a semantics analysis module, for example, the semantics analysis module 17, configured to perform positive review analysis such as semantics analysis, text mining, etc. on the positive review information of the product review message(s), and generate at least one semantically meaningful positive keyword based on the review analysis performed. The generated positive keyword(s) can be used to generate at least one positive feature point. The technique(s) and tool(s) employed in performing the positive review analysis can include text segmentation tools such as Jieba, Chinese Knowledge and Information Processing (CKIP) tools, etc., Natural Language Toolkit (NLTK) applicable to Python programs, latent semantics analysis (LSA) tools, etc. At least one of the remote computing device 1 and at least one client device 2 is configured to add the generated positive keyword(s) of the product in at least one positive keyword field of the product data thereof in, and thereby update, the product data collection 182, and in certain embodiments, also that in the product data collection(s) of at least one client device(s) 2, and thereby update the product data collection(s). Accordingly, at least one webpage of the product review website 4 that corresponds to the product can contain positive feature point(s) displayable through a browser application program on a client device 2 and/or the remote computing device 1. As a result, with more users involving in writing reviews for the product, more positive feature points can be generated and included in the positive feature field(s) of the piece of product data of the product, as well as displayed on the webpage(s) of the product review website 4 that corresponds to the product.

Likewise, at least one of the remote computing device 1 and at least one client device 2 has a semantics analysis module, for example, the semantics analysis module 17, that is configured to perform negative review analysis such as semantics analysis, text mining, etc. on the negative review information of the product review message(s), and generate at least one semantically meaningful negative keyword based on the review analysis performed. The generated negative keyword(s) can be used to generate at least one negative feature point. The technique(s) and tools employed in performing the negative review analysis can include text segmentation tools, for example, Jieba, CKIP tools, etc., NLTK applicable to Python programs, LSA tools, etc. At least one of the remote computing device 1 and at least one client device 2 is configured to add the generated negative keyword(s) of the product in at least one negative keyword field of the piece of product data thereof in, and thereby update, the product data collection 182, and in certain embodiments, also that in the product data collection(s) of at least one client device(s) 2, and thereby update the product data collection(s). Accordingly, at least one webpage of the product review website 4 that corresponds to the product can contain negative feature point(s) displayable through a browser application program on a client device 2 and/or the remote computing device 1. Accordingly, with more users involving in reviewing the product, more negative feature points can be generated and included in the negative feature field(s) of the piece of product data of the product, as well as displayed on the webpage(s) of the product review website that corresponds to the product.

The sequence of performing the positive review analysis and the negative review analysis and adding and updating product data collection(s) with the positive and negative keywords can be varied as desired and is not necessarily in the order of the description above. Further, as a product review message or information inputted by a user may contain positive review information but not negative review information, or contain negative review information but not positive review information, the remote computing device 1, and/or at least one client device 2, may accordingly omit certain analysis described above in response to determining that such information is absent.

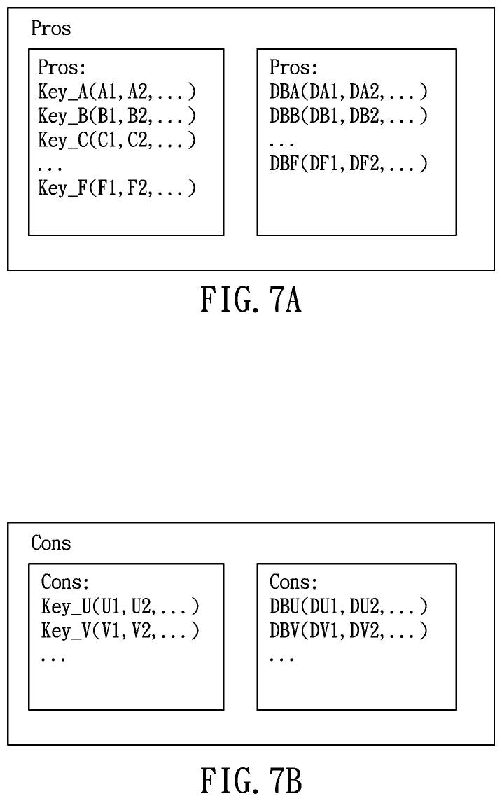

In certain embodiments, at least one of the remote computing device 1 and at least one client device 2 has a semantics analysis module, for example, the semantics analysis module 17, that performs semantics analysis, such as segmentation, decomposition, factorization or in any other way that systematically breaks down text, information extraction, etc., on the text information of all of the review title(s) and/or review bod(ies) received from or inputted in a client device 2 or the remote computing device 1; based on the text information of each of the review title(s) and the review bod(ies), generate at least one semantically meaningful keyword that is either a positive keyword or a negative keyword as the result of the semantics analysis; and store the generated keyword(s) of each review title or review body as a key array. Referring to FIG. 7A, for example, a first plurality of positive keywords A1, A2, etc. may be generated by the semantics analysis module 17 and/or the semantics analysis module of at least one client device 2 from the text in the exemplary review title TTA through segmentation, decomposition, factorization, information extraction, or other semantics analysis techniques, and stored as a first key array Key_A(A1, A2, . . . ); and a second plurality of positive keywords DA1, DA2, etc. may be generated by the semantics analysis module 17 and/or the semantics analysis module of at least one client device 2 from the text in the exemplary review body DBA through segmentation, decomposition, factorization, information extraction, or other semantics analysis techniques, and stored as a second key array DBA(DA1, DA2, . . . ), and assigned with an indication of correspondence with the first key array Key_A(A1, A2, . . . ) by the remote computing device 1 or the client device 2. Similarly, referring to FIGS. 6-7B, should another user Tester2 fill in opinions and such opinions be displayed in the Pros and Cons sections of a review or product main page of the exemplary smart watch product, keywords C1, C2, V1, V2, etc. and key arrays Key_C(C1, C2, . . . ) and Key_V(V1, V2, . . . ) can be generated from the review titles exemplarily shown as TTC and TTV. In certain embodiments, semantics analysis and keyword and key array generation and storage may be performed only to review titles and not to review bodies.

In certain embodiments, the positive and negative review analysis and positive and negative keyword generation, including segmenting the text of review information into semantically meaningful keywords, can include extracting linguistic units from the text information, mapping the linguistic units with a predefined meaningful linguistic unit data collection that is stored in a storage device of, or external of and independent from, the remote computing device 1, and generating the positive and negative keywords according to the mapping. The predefined meaningful linguistic unit data collection includes information of meaningful linguistic units, such as “color”, and of relevant linguistic units that are predefined to be related to the meaningful linguistic units, such as “colorful”. The mapping includes comparing the extracted linguistic units with the meaningful linguistic units and relevant linguistic units; in response to determining that an extracted linguistic unit is a meaningful linguistic unit in the meaningful linguistic unit data collection, define the meaningful linguistic unit as the keyword, or in response to determining that an extracted linguistic unit is a relevant linguistic unit, for example, “colorful”, define the meaningful linguistic unit in the meaningful linguistic unit data that corresponds to the relevant linguistic unit, for example, “color”, as the keyword; and in response to determining that no extracted linguistic unit corresponds to the meaningful linguistic units or relevant linguistic units, end the mapping and therefore no keyword is generated.

In certain embodiments, the positive keywords in the form of a key array, that is, a positive-keyword array, and the positive-keyword array itself, correspond to the positive review input field(s) inputted with the text data from which the positive keywords and the positive-keyword array are generated, and each positive-keyword array can correspond to a different positive review input field. For example, referring again to FIGS. 5-7A, the exemplary review title key arrays Key_A(A1, A2, . . . ), Key_B(B1, B2, . . . ), Key_C(C1, C2, . . . ), Key_F(F1, F2, . . . ), etc. respectively contain keywords A1, A2, B1, B2, C1, C2, F1, F2, etc. that can be generated respectively from the text in review titles TTA, TTB, TTC, TTF, etc., and the exemplary review body key arrays DBA(DA1, DA2, . . . ), DBB(DB1, DB2, . . . ), DBF(DF1, DF2, . . . ), etc. that are generated from the text in review bodies DBA, DBB, DBF, etc. respectively contain keywords DA1, DA2, DB1, DB2, DF1, DF2, etc. Similarly, the negative keywords in the form of a key array, that is, a negative-keyword array, and the negative-keyword array itself, correspond to the negative review input field(s) inputted with the text data from which the negative keywords and the negative-keyword array are generated, and each negative-keyword array can correspond to a different negative review input field. For example, referring to FIGS. 5, 6 and 7B, the exemplary review title key arrays Key_U(U1, U2, . . . ), Key_V(V1, V2, . . . ), etc. respectively contain keywords U1, U2, V1, V2, etc. that are generated respectively from the text in review titles TTU, TTV, etc., and the exemplary review body key arrays DBU(DU1, DU2, . . . ) and DBV(DV1, DV2, . . . ) that are generated respectively from the text in review bodies DBU and DBV respectively contain keywords DU1, DU2, DV1, DV2, etc.

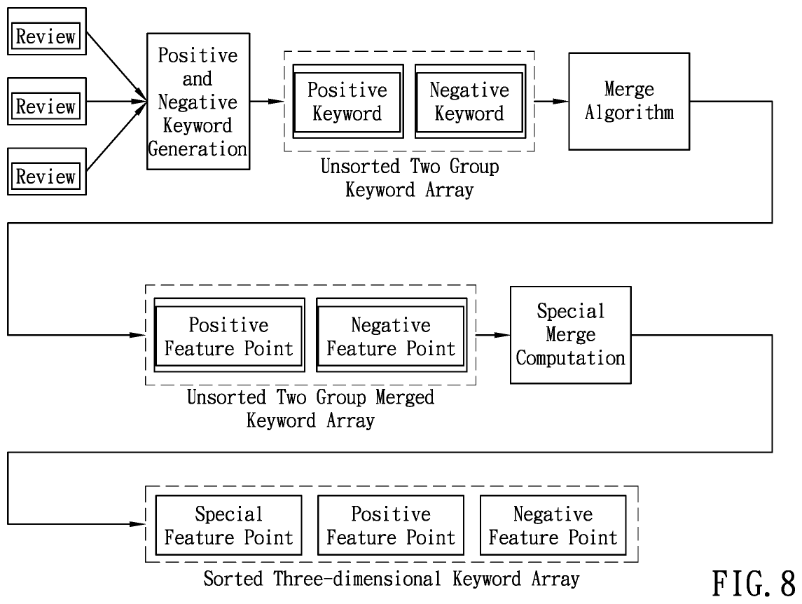

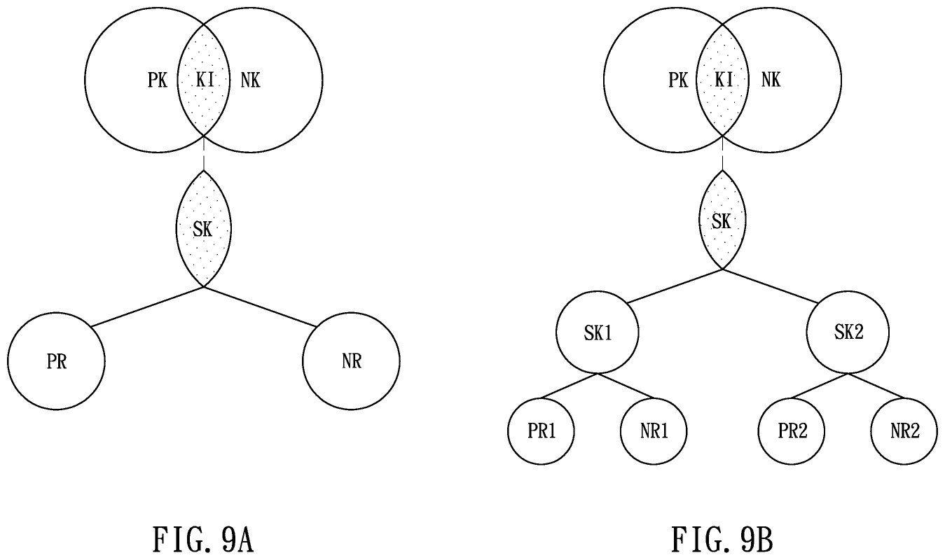

Referring to FIG. 8, the positive keywords, in certain embodiments in the form of positive-keyword arrays, that are generated from the positive review(s) can form a first group of an unsorted two group keyword array, and can be performed by the feature point generation module 16 and the semantics analysis module 17, and/or the feature point generation module and the semantics analysis module of at least one client device 2, with positive-keyword merge algorithm computation to generate at least one positive feature point. Similarly, the negative keywords, in certain embodiments in the form of negative-keyword arrays, that are generated from the negative review(s) can form a second group of the unsorted two group keyword array, and can be performed with negative-keyword merge algorithm computation to generate at least one negative feature point.

However, the present disclosure is not limited to the description supra, and the described semantics analysis and keyword and key array generation and storage can be performed on all or part of the review title(s), review bod(ies), review abstract(s) and any other review information related to a product listed on the product review website 4. In particular, the semantically meaningful positive keywords generated by the semantics analysis module 17 of the remote computing device 1, and/or by the semantics analysis module of at least one client device 2, can be based on all or part of the positive review information of the product that is inputted by the user(s) reviewing the product in the positive review input fields, such as the review title fields, review body fields, review abstract(s) and/or any other review information on the review page(s) thereof. In certain embodiments, the positive review information includes all of the information inputted in the positive review input fields of all the reviews of the goods or service by different users. Likewise, the semantically meaningful negative keywords generated by the semantics analysis module 17, and/or by the semantics analysis module of at least one client device 2, can be based on all or part of the negative review information of the product that is inputted by the user(s) reviewing the product in the negative review input fields, such as the review title fields, review body fields, review abstract(s) and/or any other review information on the review page(s) thereof. In certain embodiments, the negative review information includes all of the information inputted in the negative review input fields of all the reviews of the product by different users. In other words, the positive or negative review information based on which the semantically meaningful positive or negative keyword(s) is generated can be all or part of the positive or negative review information inputted by one user on the same single review or multiple reviews created by the user and, under a condition that a review corresponds to a product review message, corresponding to and contained in one or more product review messages; or can be all or part of the positive or negative review information inputted by multiple users on multiple reviews created by multiple users and, under a condition that a review corresponds to a product review message, corresponding to and contained in multiple product review messages.

The keywords and key arrays generated are then used by the various opinion evaluation system according to the present disclosure to generate at least one special feature point. As described supra, a special feature point according to the present disclosure can identify conflict points of a topic, that is, the intersection of positive evaluation and negative evaluation. Referring to FIGS. 9A and 9B, a keyword in the intersection KI of a set of positive keyword(s) PK and a set of negative keyword(s) NK has attribute(s) that suit it both as a positive keyword and a negative keyword, which may suit it both as a positive feature point and as a negative feature point, and therefore a special feature point. Such a keyword can be present both in at least one positive review PR and at least one negative review NR of a piece of goods or a service and/or be generated or retrieved both from the positive review(s) PR and from the negative review(s) NR, and therefore is referred to in the present disclosure as a common keyword or special keyword SK. On the contrary, if a keyword only presents and/or is capable of being generated only from either the positive review(s) PR or the negative review(s) NR, such a keyword is determined by at least one feature point generation module of at least one of the remote computing device 1 and at least one client device 2, for example, the feature point generation module 16, to be a one-sided keyword and not employed in its special feature point generation process. In certain embodiments, referring to FIG. 9B, the intersection KI includes a plurality of special keywords SK including a first special keyword SK1 and a second special keyword SK2, the first special keyword SK1 is present both in, and/or generated or retrieved both from, at least one first positive review PR1 and at least one first negative review NR1 of a piece of goods or a service, the second special keyword SK2 is present both in, and/or generated or retrieved both from, at least one second positive review PR2 and at least one second negative review NR2 of a second piece of goods or service, wherein the first special keyword SK1 is different from the second special keyword SK2, the first positive review PR1 is the same as or different from the second positive review PR2, the first negative review NR1 is the same as or different from the second negative review NR2, and the first goods or service is the same or different from the second goods or service. In certain embodiments, at least one of the remote computing device 1 and at least one client device 2 has a semantics analysis module, for example, the semantics analysis module 17, configured to compare a first keyword generated or retrieved from one of at least one positive review and at least one negative review with a second keyword generated or retrieved from another one of the at least one positive review and at least one negative review. For example, the semantics analysis module 17, and/or the semantics analysis module of at least one client device 2, can individually or collectively compare a first keyword generated from a positive review and a second keyword generated from a negative review; determine whether the first keyword is semantically similar to or the same as the second keyword based on, for example, but not limited to, a predetermined fixed or variant similarity threshold and/or a semantic overlapping data collection as described infra; determine that the first keyword is semantically similar to or the same as the second keyword in response to determining the similarity therebetween equal to or exceeding the similarity threshold and/or the first and second keywords corresponding to at least one same semantic node in the semantic overlapping data collection; determine that the first keyword is not semantically similar to the second keyword in response to determining the similarity therebetween is below the similarity threshold and/or that the first and second keywords does not correspond to any same semantic node in the semantic overlapping data collection; in response to determining the first and second keywords are semantically similar or the same, merge the first keyword with the second keyword according to a special merge algorithm; and generate at least one special feature point according to the merge of the first and second keywords. However, the present disclosure is not limited thereto, and a keyword merge may be performed on more than two keywords among which each is a keyword generated from a positive review or a negative review.

In certain embodiments, at least one of the remote computing device 1 and at least one client device 2 is configured to retrieve part or all of the positive keywords in the keyword information of the product data corresponding to the goods or service in the product data collection 182, and/or that in the product data collection of at least one client device 2; merge the retrieved positive keyword(s) according to a positive-keyword merge algorithm; and generate at least one positive feature point having a first weighting value according to the merge of the positive keyword(s). In certain embodiments, the remote computing device 1 and/or at least one client device 2, collectively or individually, through the positive-keyword merge algorithm, can merge the positive keywords by employing semantics analysis techniques on the positive keywords in the positive key arrays, and individually or collectively by the semantics analysis module 17 and/or the semantics analysis module of at least one client device 2, can assign positive keywords having semantic overlapping, that is, sharing semantic similarity, into the same semantic group, therefore forming one or multiple semantic groups based on the respective semantic attributes of all positive keywords. In certain embodiments, positive keywords having semantic overlapping are assigned into the same semantic group based on the semantic overlapping data collection that is stored in a storage device of, or external of and independent from, the remote computing device 1. The semantic overlapping data collection includes information of meaningful linguistic units that have semantic overlapping, such as hypernyms, hyponyms, synonyms, etc., and that are arranged as semantic nodes, and of the predefined similarity value(s) given to any two meaningful linguistic units of a semantic node. In response to determining two positive keywords correspond to the same first semantic node, the two positive keywords are assigned into the same semantic group, and another positive keyword is assigned into the same semantic group in response to determining that the another positive keyword and any of the two positive keywords correspond to the same second semantic node that is the same or different from the first semantic node.

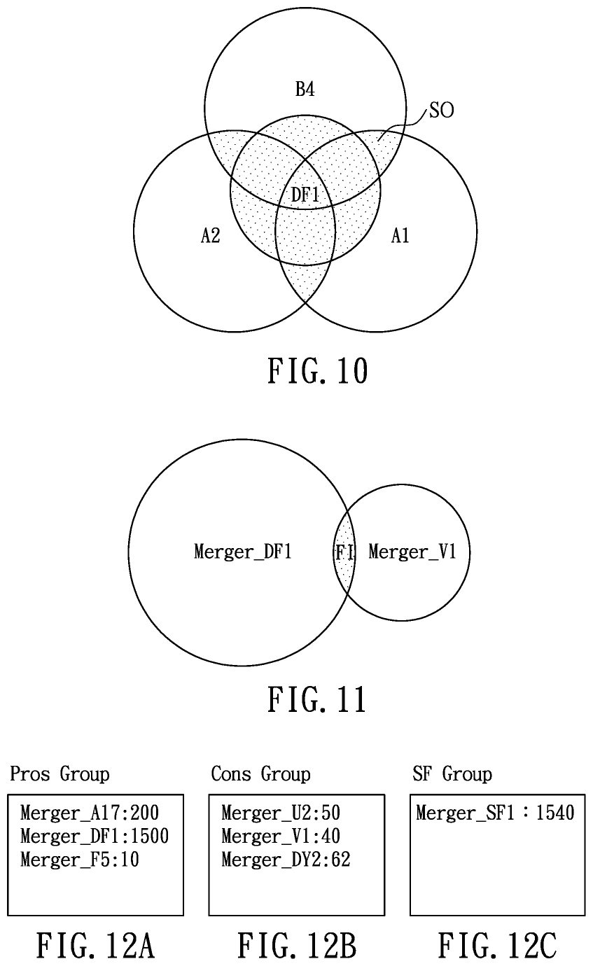

For example, referring to FIGS. 7A and 10, assuming that a plurality of positive key arrays of the same goods or service include the exemplary key arrays Key_A, Key_B and Key_F and DBA, DBB and DBF that are associated therewith, and the positive keywords A1 and A2 in Key_A, positive keyword B4 in Key_B and positive keyword DF1 in DBF semantically overlap one another, with all the semantic overlapping parts shown as a dotted semantically overlapping portion SO in FIG. 10. The semantics analysis module 17 and/or the semantics analysis module of at least one client device 2, individually or collectively, can perform semantics analysis on the positive key arrays, and the feature point generation module 16 and/or the feature point generation module of at least one client device 2, individually or collectively, can generate at least one positive feature point by defining the positive keyword in a semantic group that accounts for the largest portion of the semantically overlapping portion SO as the positive feature point, such as the keyword DF1 shown in FIG. 10, which accounts for the largest portion of the semantically overlapping portion SO of the semantic group it belongs to. In certain embodiments, the semantics analysis module 17 and/or the semantics analysis module of at least one client device 2, individually or collectively, can determine a semantic overlapping degree of a semantic group that is any semantic overlapping between any two semantically meaningful positive keywords in the same semantic group, for example, the sum of the predefined similarity values between any two semantically meaningful positive keywords in the same semantic group as defined in the semantic overlapping data collection; and determine a semantic overlapping ratio of each of the positive keywords in the same semantic group that is a ratio of any semantic overlapping between the positive keyword and any other positive keyword in the same semantic group to the semantic overlapping degree, for example, the sum of the predefined similarity value(s) between the positive keyword and any other positive keyword in the same semantic group as defined in the semantic overlapping data collection to the semantic overlapping degree. The feature point generation module 16 and/or the feature point generation module of at least one client device 2, individually or collectively, can define one of the positive keywords in the same semantic group that has a highest semantic overlapping ratio among the semantic overlapping ratios as the positive feature point. Referring to FIGS. 10 and 12A, the positive keyword DF1 can be defined as a positive feature point Merger_DF1. Such positive feature point(s) collectively forms a Pros group. In certain embodiments, the semantics analysis module 17 and/or the semantics analysis module of at least one client device 2, individually or collectively, can determine, for each of the positive keywords in the same semantic group, the sum of the predefined similarity value(s) between the positive keyword and any other positive keyword in the same semantic group as defined in the semantic overlapping data collection; and the feature point generation module 16 and/or the feature point generation module of at least one client device 2, individually or collectively, can define one of the positive keywords in the same semantic group that has a highest sum of the predefined similarity value(s) between the positive keyword and any other positive keyword in the same semantic group as the positive feature point. The feature point generation module 16 and/or the feature point generation module of at least one client device 2, individually or collectively, can further define the weighting value of a positive feature point as the sum of the weighting values of the positive keywords of the semantic group to which the positive feature point belongs, for example, referring to FIG. 10, the weighting value of Merger_DF1 is the sum of the weighting values of the positive keywords A1, A2, B4 and DF1, taking into account the number of as well as the respective weighting values of the positive keywords merged. Accordingly, referring to FIG. 8, the generated positive feature point(s) with its weighting value calculated as described supra forms a first group of an unsorted two group merged keyword array.

In certain embodiments, at least one of the remote computing device 1 and at least one client device 2 is configured to retrieve part or all of the negative keywords in the keyword information of the product data corresponding to the goods or service in the product data collection 182, and/or that in the product data collection of at least one client device 2; merge the retrieved negative keyword(s) according to a negative-keyword merge algorithm; and generate at least one negative feature point having a second weighting value according to the merge of the negative keyword(s). In certain embodiments, the remote computing device 1 and/or at least one client device 2, collectively or individually, through the negative-keyword merge algorithm, can merge the negative keywords by employing semantics analysis techniques on the negative keywords in the negative key arrays, and individually or collectively by the semantics analysis module 17 and/or by the semantics analysis module of at least one client device 2, can assign negative keywords having semantic overlapping, that is, sharing semantic similarity, into the same semantic group, therefore forming one or multiple semantic groups based on the respective semantic attributes of all negative keywords. In certain embodiments, negative keywords having semantic overlapping are assigned into the same semantic group based on the semantic overlapping data collection. In response to determining two negative keywords correspond to the same semantic node, the two negative keywords are assigned into the same semantic group, and another negative keyword is assigned into the same semantic group in response to determining that the another negative keyword and any of the two negative keywords correspond to the same semantic node that is the same or different of the semantic node of the two negative keywords.

For example, assuming that a plurality of negative key arrays have several negative keywords semantically overlapping one another, and collectively form a semantically overlapping portion, the semantics analysis module 17 and/or the semantics analysis module of at least one client device 2, individually or collectively, can perform semantics analysis on the negative key arrays, and the feature point generation module 16 and/or the feature point generation module of at least one client device 2, individually or collectively, can generate at least one negative feature point by defining the negative keyword in a semantic group that accounts for the largest portion of the semantically overlapping portion as the negative feature point.

For example, referring to FIG. 12B, a negative keyword U2 accounts for the largest portion of the semantically overlapping portion of a semantic group it belongs to is defined as a negative feature point Merger_U2. In certain embodiments, the semantics analysis module 17 and/or the semantics analysis module of at least one client device 2, individually or collectively, can determine a semantic overlapping degree of a semantic group that is any semantic overlapping between any two semantically meaningful negative keywords in the same semantic group, for example, the sum of the predefined similarity values between any two semantically meaningful negative keywords in the same semantic group as defined in the semantic overlapping data collection; and determine a semantic overlapping ratio of each of the negative keywords in the same semantic group that is a ratio of any semantic overlapping between the negative keyword and any other negative keyword in the same semantic group to the semantic overlapping degree, for example, the sum of the predefined similarity value(s) between the negative keyword and any other negative keyword in the same semantic group as defined in the semantic overlapping data collection to the semantic overlapping degree. The feature point generation module 16 and/or the feature point generation module of at least one client device 2, individually or collectively, can define one of the negative keywords in the same semantic group that has a highest semantic overlapping ratio among the semantic overlapping ratios as the negative feature point. Such negative feature point(s) collectively forms a Cons group. In certain embodiments, the semantics analysis module 17 and/or the semantics analysis module of at least one client device 2, individually or collectively, can determine, for each of the negative keywords in the same semantic group, the sum of the predefined similarity value(s) between the negative keyword and any other negative keyword in the same semantic group as defined in the semantic overlapping data collection; and the feature point generation module 16 and/or the feature point generation module of at least one client device 2, individually or collectively, can define one of the negative keywords in the same semantic group that has a highest sum of the predefined similarity value(s) between the negative keyword and any other negative keyword in the same semantic group as the negative feature point. The feature point generation module 16 and/or the feature point generation module of at least one client device 2, individually or collectively, can further define the weighting value of the negative feature point as the sum of the weighting values of negative keywords of the same semantic group to which the negative feature point belongs, therefore taking into account the number of as well as the respective weighting values of the negative keywords merged. Accordingly, referring to FIG. 8, the generated negative feature point(s) with its weighting value calculated as described supra forms a second group of the unsorted two group merged keyword array. In certain embodiments, referring to FIGS. 12A and 12B, with more reviews being inputted for a piece of goods or a service on the product review website 4, multiple positive feature points and/or multiple negative feature points can be generated, and assigned in the Pros and Cons groups, respectively.

Referring again to FIG. 8, based on the generated positive and negative feature points in the unsorted two group merged keyword array, the feature point generation module 16 and/or the feature point generation module of at least one client device 2, individually or collectively, can generate at least one special feature point through special merge computation that is part of SFG ALG and based on a feature-point merge algorithm. In certain embodiments, the remote computing device 1 and/or at least one client device 2, individually or collectively, can merge the positive feature point(s) and the negative feature point(s) of a piece of goods or a service according to the feature-point merge algorithm, and generate at least one special feature point based on the merge of the positive and negative feature points. The remote computing device 1 and/or at least one client device 2, individually or collectively, can merge the positive and negative feature points by: the semantics analysis module 17 and/or the semantics analysis module of at least one client device 2 comparing the text of the positive feature point(s) with the text of the negative feature point(s) and identifying at least one meaningful linguistic unit, such as a phrase, a word, a sentence, the feature point itself, etc., that exists both in the positive feature point(s) and the negative feature point(s); and the feature point generation module 16 and/or the feature point generation module of at least one client device 2 defining the meaningful linguistic unit as the special feature point(s). As shown in FIG. 12C, the special feature point(s) collectively forms a special feature group. Accordingly, a sorted three-dimensional keyword array that includes the special feature point(s), positive feature point(s), and negative feature point(s) can be formed as a result of the special merge computation. That is, through SFG ALG, particularly special merge computation, two-dimensional information directed to positive-feature and negative-feature dimensions can be converted into three-dimensional information directed to positive-feature, negative-feature and special-feature dimensions, which adds higher marketing and business values to the feature points sorted out by the processes. The processes and result of the special merge computation, individually or collectively, do not affect or change the positive feature point(s), the negative feature point(s), or the positive and negative keywords from which the feature points are generated.

The process of the special merge computation and configuration of the feature point generation module 16 and/or of the feature point generation module of at least one client device 2 for the special feature point generation will be better understood through the examples infra. Referring to FIGS. 5, 6 and 11-13, assuming that a common meaningful linguistic unit 41, for example, “stainless steel”, exists both in a positive feature point Merger_DF1 and a negative feature point Merger_V1, that is, in the feature point intersection FI of the positive feature point Merger_DF1 and the negative feature point Merger_V1, the semantics analysis module 17 and/or the semantics analysis module of at least one client device 2 can compare the text of the positive feature point Merger_DF1 with the text of negative feature point Merger_V1, and identify the common meaningful linguistic unit 41, “stainless steel”, by determining that it exists both in the positive feature point and the negative feature point based on the comparison, and in response to the semantics analysis module 17 and/or the semantics analysis module of at least one client device 2 determining that at least one common meaningful linguistic unit 41 exists both in the positive feature point and the negative feature point, the feature point generation module 16 and/or the feature point generation module of at least one client device 2 can define the meaningful linguistic unit 41, exemplarily “stainless steel”, as a special feature point, which forms a special feature group with, if any, other special feature points, and define a weighting value of the special feature point as the sum of the respective weighting values of the positive feature point(s) and the negative feature point(s) based on which the special feature point is generated. For example, referring to FIGS. 11-12C, the weighting value of the special feature point Merger_SF1 is set to 1540, which is the sum of the weighting value of Merger_DF1, 1500, in the Pros group and the weighting value of Merger_V1, 40, in the Cons Group.

In certain embodiments, the special merge computation involves a balance curve algorithm to generate at least one special feature point from semantically similar linguistic units in the positive and negative feature points. When at least one linguistic unit in at least one positive feature point shares semantic similarity with, but is not entirely the same in its character form or semantic meaning as, for example, being a hypernym, a hyponym, a synonym, etc. of, at least one linguistic unit in at least one negative feature point, these corresponding linguistic units are referred to as semantically similar linguistic units, and the positive and negative feature points as semantically similar feature points. At least one of the remote computing device 1 and at least one client device 2 has a semantics analysis module, for example, the semantics analysis module 17, configured to determine whether at least one first linguistic unit in at least one positive feature point and at least one second linguistic unit in at least one negative feature point are semantically similar linguistic units, for example, based on the semantic overlapping data collection, and whether at least one positive feature point and at least one negative feature point are semantically similar feature points, and designate one of the semantically similar linguistic units as the common meaningful linguistic unit. At least one of the remote computing device 1 and at least one client device 2 has a feature point generation module, for example, the feature point generation module 16, configured to generate at least one special feature point based on the balance curve algorithm in response to the semantics analysis module 17 and/or the semantics analysis module of at least one client device 2 determining the linguistic units are semantically similar linguistic units and the positive feature point(s) and the negative feature point(s) are semantically similar feature points, for example, in response to receiving a message sent from the semantics analysis module 17 or the semantics analysis module of at least one client device 2 indicating that the linguistic units are semantically similar linguistic units and the positive feature point(s) and the negative feature point(s) are semantically similar feature points.

In certain embodiments, the semantics analysis module 17 and/or the semantics analysis module of at least one client device 2, individually or collectively, can perform semantics analysis on the positive feature point(s) and the negative feature point(s); generate positive and negative meaningful linguistic units respectively from the positive feature point(s) and negative feature point(s) based on the semantics analysis, for example, each of the positive feature point(s) and negative feature point(s) may be segmented into, and/or itself be treated as, at least one meaningful linguistic unit; determine whether at least one first linguistic unit in at least one positive feature point and at least one second linguistic unit in at least one negative feature point are semantically similar linguistic units for example, based on the semantic overlapping data collection, and whether at least one positive feature point and at least one negative feature point are semantically similar feature points according to the semantics analysis; and store the semantic similarity information of the semantically similar linguistic units and feature points, including the identities and similarity correspondence of the semantically similar linguistic units and feature points, as a linguistic-unit-and-feature-point-semantical-similarity data collection in the datastore 18 or in another datastore or storage device as part of or independent from the product data collection 182, and/or in the datastore of at least one client device 2.

In certain embodiments, the semantics analysis module 17 and/or the semantics analysis module of at least one client device 2, individually or collectively, can compare the positive meaningful linguistic unit(s) of the positive feature point(s) with the negative meaningful linguistic unit(s) of the negative feature point(s); determine whether at least one common meaningful linguistic unit exists both in the positive feature point(s) and the negative feature point(s) based on the comparison; determine whether or not the common meaningful linguistic unit is a positive feature point or a negative feature point; in response to determining no common meaningful linguistic unit exists both in the positive feature point(s) and the negative feature point(s), end the special merge computation or, based on the semantic overlapping data collection, determine whether at least one first linguistic unit in at least one positive feature point and at least one second linguistic unit in at least one negative feature point are semantically similar linguistic units, and whether the positive feature point and the negative feature point from which the positive and negative meaningful linguistic units are generated are semantically similar feature points; in response to determining at least one first linguistic unit in at least one positive feature point and at least one second linguistic unit in at least one negative feature point are semantically similar linguistic units, designate one of the semantically similar linguistic units as the common meaningful linguistic unit; and in response to determining no linguistic unit in at least one positive feature point is a semantically similar linguistic unit to any linguistic unit in at least one negative feature point, end the special merge computation.

At least one of the remote computing device 1 and at least one client device 2 has a feature point generation module, for example, the feature point generation module 16, configured to, in response to the semantics analysis module 17 and/or the semantics analysis module of at least one client device 2 determining the common meaningful linguistic unit is a positive feature point or a negative feature point, define the positive feature point or the negative feature point as the special feature point; in response to determining the positive feature point and the negative feature point from which the designated common meaningful linguistic unit is generated are semantically similar feature points, generate at least one special feature point that is either the positive feature point, the negative feature point, or the common meaningful linguistic unit based on the balance curve algorithm. In certain embodiments, the feature point generation module 16 and/or the feature point generation module of at least one client device 2, individually or collectively, can apply the balance curve algorithm to the feature points and the meaningful linguistic units thereof in response to determining the common meaningful linguistic unit is not a positive feature point and not a negative feature point, and therefore the determination of the semantic similarity of the feature points can be omitted. In certain embodiments, the feature point generation module 16 and/or the feature point generation module of at least one client device 2, individually or collectively, can define the at least one common meaningful linguistic unit as a special feature point in response to determining at least one common meaningful linguistic unit exists both in the positive feature point(s) and the negative feature point(s), and therefore the application of the balance curve algorithm and determination of whether the common meaningful linguistic unit is a positive feature point or a negative feature point can be omitted.

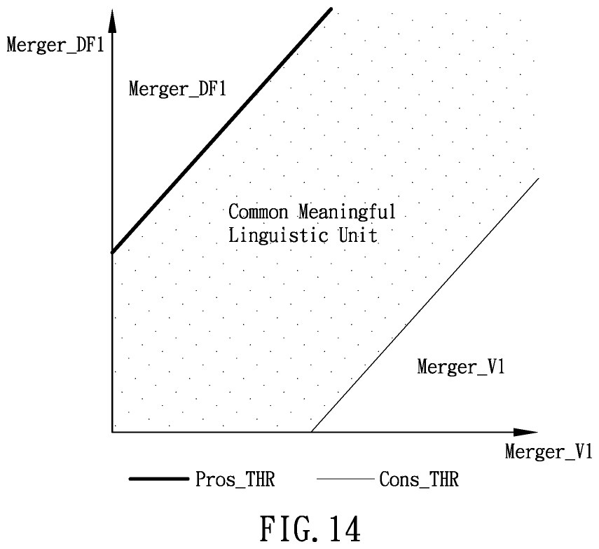

Referring to FIG. 14, in certain embodiments, the execution of the balance curve algorithm of the feature point generation module 16 and/or the feature point generation module of at least one client device 2 is based on a predetermined positive-feature threshold, a predetermined negative-feature threshold, and merge information that includes the weighting value of the positive feature point, the text information of the positive feature point, the weighting value of the negative feature point, the text information of the negative feature point, and the text information of the at least one common meaningful linguistic unit that exists both in the positive feature point and the negative feature point or that is designated. At least one of the remote computing device 1 and at least one client device 2 has a feature point generation module, for example, the feature point generation module 16, configured to generate a first numeral value according to the weighting values of the positive and negative feature points and a second numeral value according to the weighting values of the positive and negative feature points; determine whether the first numeral value is greater than the predetermined positive-feature threshold; determine whether the second numeral value is greater than the predetermined negative-feature threshold; in response to determining the first numeral value is greater than the predetermined positive-feature threshold, defining and outputting the positive feature point as the special feature point; in response to determining the second numeral value is greater than the predetermined negative-feature threshold, defining and outputting the negative feature point as the special feature point; in response to determining the first numeral value is smaller than the predetermined positive-feature threshold and the second numeral value is smaller than the predetermined negative-feature threshold, defining and outputting the common meaningful linguistic unit as the special feature point. In certain embodiments, in response to determining the first numeral value is equal to or smaller to the predetermined positive-feature threshold and the second numeral value is equal to or smaller to the predetermined negative-feature threshold, the feature point generation module 16 and/or the feature point generation module of at least one client device 2, individually or collectively, can define and output the common meaningful linguistic unit as the special feature point. However, the present disclosure is not limited thereto, and in certain embodiments, a feature point generation module is configured to, in response to determining the first numeral value is equal to the predetermined positive-feature threshold, define and output the positive feature point as the special feature point, and/or in response to determining the second numeral value is equal to the predetermined negative-feature threshold, define and output the negative feature point as the special feature point. In certain embodiments, the first numeral value is generated by the feature point generation module 16 and/or the feature point generation module of at least one client device 2 by subtracting the weighting value of the negative feature point from the weighting value of the positive feature point, and the second numeral value is generated by subtracting the weighting value of the positive feature point from the weighting value of the negative feature point.

For example, referring to FIG. 14, in response to determining a numeral value generated based on the positive feature point Merger_DF1 and the negative feature point Merger_V1, such as subtracting the weighting value of Merger_V1 from the weighting value of Merger_DF1, is greater than a positive feature threshold Pros_THR, the feature point generation module 16 and/or the feature point generation module of at least one client device 2, individually or collectively, can define and output the positive feature point Merger_DF1 as the special feature point. In response to determining a numeral value generated based on the positive feature point Merger_DF1 and the negative feature point Merger_V1, such as subtracting the weighting value of Merger_DF1 from the weighting value of Merger_V1, is greater than a negative feature threshold Cons_THR, the feature point generation module 16 and/or the feature point generation module of at least one client device 2, individually or collectively, can define and output the negative feature point Merger_V1 as the special feature point. In response to determining that a numeral value satisfies neither of the above conditions, the feature point generation module 16 and/or the feature point generation module of at least one client device 2, individually or collectively, can output at least one common meaningful linguistic unit(s) that exists both in the positive feature point Merger_DF1 and the negative feature point Merger_V1 or is designated as the special feature point.

In certain embodiments, the afore-referenced tasks including keyword generation and retrieval, keyword merge, feature point merge, and/or feature point generation may be set to be performed on a daily base. However, the present disclosure is not limited thereto. Based on practical needs and the loading of and exerted on the remote computing device 1 and/or at least one client device 2, the time interval of the tasks may be shorter or longer, or the tasks may be performed real-time, for example, whenever a user adds any review content for a piece of goods or a service.

Accordingly, when a user, through a client device 2 or a remote computing device 1, browses on a product page for a particular piece of goods or service on the product review website 4, such as the exemplary smart watch review page(s) described supra, at least one special feature point, such as “stainless steel”, can be displayed on such a page. In certain embodiments, should there be a plurality of special feature points, the remote computing device 1 is configured to sort the special feature points in the order of their weighting values, for example, descending from the one having the highest value to the one having the lowest value, and place a special feature point that has a greater weighting value to a more noticeable location on a page for the goods or service on the product review website 4, so that a user may discern such a special feature point more swiftly on the page. Accordingly, as a special feature point is usually a meaningful linguistic unit that is of a more subjective character, while the positive and negative feature points are that of a more objective character, with the aid of the special feature point(s) according to the present disclosure, users can swiftly grasp the topicality of or the controversy related to a piece of goods or service, without spending excessive effort and time to go through comments that are of more objective characters, which effectively improves the effectiveness and presentation structure of the keyword/feature point information displayed on the review website 4.

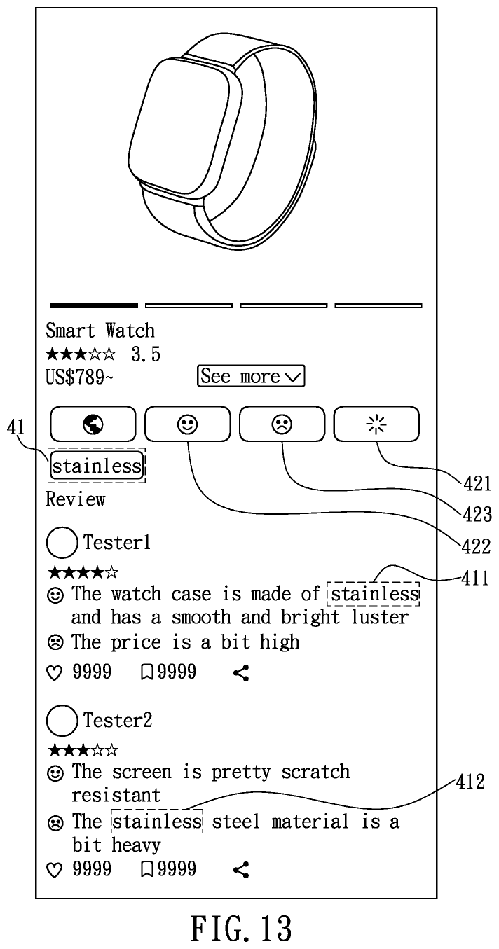

Reference is made again to the afore-referenced smart watch product as an exemplary product employing the various opinion evaluation system according to the present disclosure, as well as to FIGS. 5, 6 and 13, which show how the special feature point(s) generated according to the present disclosure allows users to grasp the subjective characters more swiftly, and serve also as topical linguistic units to allow users to understand the topicality of the goods or service in social communities. The positive and negative feature points that are generated from the content of positive and negative reviews of the smart watch product by different users on the product review website 4 may have at least one common meaningful linguistic unit, for example, the “stainless steel” feature as shown in broken-line blocks 411 and 412 in FIGS. 5 and 6, which can be displayed as a special feature point such as that shown in the broken-line block 41 in FIG. 13 on a product page of the smart watch product on the product review website 4. Accordingly, users can swiftly recognize that a special feature of the product, that is, the smart watch, is stainless. In certain embodiments, a user can click on virtual buttons displayed on the page(s) of the goods or service to sort out the information that interests the user. For example, referring again to FIG. 13, a virtual button 421 can be clicked by a user for the product page to show the special feature point(s), for example, the special feature point as a meaningful linguistic unit “stainless steel” shown in the broken-line block 41, and the positive reviews and negative reviews related to the special feature point as the meaningful linguistic unit “stainless steel”, such as those shown in broken-line blocks 411 and 412 in FIGS. 5, 6 and 13 that contain the meaningful linguistic unit “stainless steel”, so that a user may swiftly and conveniently check on controversial and topical information that is less of an objective character. Similarly, a virtual button 422 can be clicked by a user on the product page to show the positive feature point(s) and the positive review(s) related to the positive feature point(s), so that a user may swiftly and conveniently check on the positive information recognized by most users that is more of an objective character, and a virtual button 423 can be clicked by a user on the product page to show the negative feature point(s) and the negative review(s) related to the negative feature point(s), so that a user may swiftly and conveniently check on the negative information recognized by most users that is more of an objective character. Accordingly, a user who holds a negative opinion on a feature presented as a special feature point according to the present disclosure, such as a user who is allergic or not fond of stainless steel, can quickly skip the product(s) associated with the special feature point, which not only saves the user's browsing time, but also keeps the user from a likely poor user experience if he or she purchases the product. In this way, with the passage of time, as a product gradually moves from an early stage to a mature stage, since the special feature point(s) according to the present disclosure allows a user to understand the conflict points of a piece of goods or a service as early as possible so as to facilitate the user to make purchase decisions according to his or her own preferences, consumers that may not be satisfied by the product can be prevented from purchasing the product in advance, and the proportion of positive reviews received by the product in the long term would increase.

In addition, from the perspectives of an business entity, since the special feature point(s) does not appear in all of the reviews of a piece of goods or a service, and once it appears, it means the special feature point(s) has become a conflict point or topical point between the supporters and the opposers of the goods or service, the marketing personnel in the business entity can set and carry out marketing strategies by using the special feature point(s) as the focal point of or as the keyword used in the marketing strategies. In this way, such marketing strategies can attract consumers interested in such keywords that are developed from the special feature point(s), and make the consumers to pay more attention on the product. In addition, as the special feature point(s) can be generated from the content of reviews by multiple users, whose reviews have been semantically analyzed to obtain positive and negative keywords, positive and negative feature points, common meaningful linguistic unit(s) and special feature point(s), such users who have left reviews on the product review website 4 can be targeted with more precise advertisement recommendation by a business entity based on the content of their reviews, for example, their preferences.

Further, as the weighting value of the special feature point(s) according to the present disclosure can take into account the respective weighting values of the positive feature point(s) and negative feature point(s), a business entity can use such a special feature point as the basis for analyzing the proportions of the supporters and the opposers of a piece of goods or service in the market, thereby avoiding statistic weighting dilution that can otherwise occur when a keyword disperses both in the positive reviews and negative reviews in a conventional review system. Further, as a product becomes more successful in a market and people gradually become more used to use and acceptive to the product, the proportion of the reviews thereof that are more subjective in character can increase. Therefore, the special feature point(s) can serve for business entities as an analysis index of the product and point a direction for the improvement of the product technique or for the technique specification in the future. Thereby, a next generation product can also be analyzed for its product positioning, and differentiation strategies that differentiate the product from its competitors can be framed. In addition, business entities can also analyze the information of the consumers attracted by the special feature point(s), and obtain the proportion change in market acceptance of different consumer groups, such as teenagers, children, white-collar workers, homemakers, etc., of the goods or service, so as to estimate the spread rate of the goods or service in different markets. Accordingly, more effective or more targeting advertising resources can be used by business entities on different consumer groups.

In certain embodiments, the remote computing device 1 is configured to prioritize feature points of a piece of goods or a service according to the popularity of the feature points. The feature points to be prioritized may be at least two of at least one special feature point, at least one positive feature point and at least one negative feature point. In certain embodiments, the popularity of a feature point to be prioritized is determined by the search therefor on the product review website 4, that is, the times the feature point has been searched in a period of time on the website. In certain embodiments, the remote computing device 1 executes a character search number algorithm to calculate and record the number of time of a feature point as a whole is searched by users on the product review website 4 as a whole keyword or as a part of the character formation of a keyword, that is, the time(s) the character(s) of the feature point(s) appears in the searched keywords in a period of time.

The remote computing device 1 is configured to determine, through the character search number algorithm, the search number of each of the special, positive and/or negative feature point(s) generated by the feature point generation module 16 and/or the feature point generation module of at least one client device 2 based on the content in the positive and negative reviews, such as the content inputted by a user for a product in the above-referenced Pros and Cons sections on a review page with the aid of the guiding of the product review website 4; and generate at least one webpage of the product review website 4 that is related to the product and places the feature point(s) at location(s) thereon in the order of user noticeability, for example, from top to the bottom of the webpage, or update at least one webpage of the product review website 4 that is related to the product to place the feature point(s) at location(s) thereon in the order of user noticeability. In certain embodiments, the remote computing device 1 generates a priority list prioritizing the feature point(s) of the goods or service based on the search number(s) of the feature point(s), and listing the feature point(s) in a priority order from high to low in positive correlation to the search number(s) of the feature point(s).

In certain embodiments, feature and search number combined linguistic unit(s) can be shown on a page related to a piece of goods or a service on the product review website 4. For example, an exemplary positive feature and search number combined linguistic unit may include a positive feature point “light and thin” affixed with a number of “2” that indicates the current search number of the feature “light and thin” on the product review website 4 is twice, which collectively are shown as, for example, “light and thin (2)”. A computer product may have positive feature and search number combined linguistic units shown on a page thereof that include “screen color (5)”, “closed system (4)”, “light and thin (2)”, “endurable (2)” and “quiet (2)”, which can be displayed in the order on the page from higher noticeability by a user to lower noticeability, for example, top to bottom based on their respective search numbers; and negative feature and search number combined linguistic units of, and in the order of, “high price (3)” and “closed system (2)”. As the feature “closed system” appears both in the positive and negative feature points and therefore is determined by the remote computing device 1 and/or at least one client device 2 to be a special feature point, its search number is determined by the remote computing device 1 and/or at least one client device 2 to be the sum of the search numbers, 4 and 2, thereof respectively in the positive and negative features, that is, 6, and is shown collectively with the feature “closed system” as a special feature and search number combined linguistic unit “closed system (6)” at a place on the page that is nearer the top thereof, or more noticeable by a user searching for products on the website, than the positive and negative feature and search number combined linguistic units.

In certain embodiments, the higher the search number of a keyword searched by users on the product review website 4 is, for example, the more times a character, a word, a phrase, a feature point, etc. appears, the priority of the keyword searched is higher, and such a keyword may be designated, and shown on pages of the product review website 4, as a trending keyword. The trending keyword(s) may be displayed on pages of the product review website 4, in addition to the positive, negative, and special feature points, with or without search number thereof attached thereto. It is noted that as a special feature point in the special feature and search number combined linguistic unit can be a keyword or a common meaningful linguistic unit that is designated or appears both in the positive and negative feature points, as exemplified in the computer product referred supra, the weighting value thereof is increased accordingly, which makes it easier to be a trending keyword. For example, a special feature point may be related to the exemplary controversial public figure referred supra, who has vast supporters as well as opposers and therefore can more easily become a trending keyword. Therefore, a supporter of the public figure can easily and swiftly use such a special feature point that is also presented as one of the trending keyword(s) on pages of the product review website 4 to browse and find a piece of goods or service related to the public figure, such as a restaurant. As for users who are not familiar with the special feature point, such a trending keyword and reviews corresponding thereto offer insight and quick access to current popular issues and trends in the general public and society.

In certain embodiments, the remote computing device 1 is configured to designate a keyword or meaningful linguistic unit as a trending keyword in response to determining its search number equals to or exceeds a search number threshold in a period of time; prioritize the trending keyword(s) according to the popularity thereof, for example, the respective search numbers thereof; and establish a trending keyword data collection that includes the identities and search number of the trending keyword(s). In certain embodiments, the trending keyword data collection and the product data collection 182 are integrated as one data collection, and the keyword information of the pieces of product data includes trending keyword designation. In certain embodiments, the remote computing device 1 is configured to designate at least one feature point of a product on the product review website 4 as a trending keyword; trace the search number; store and update the search number in the trending keyword data collection; and generate, and/or update the search number displayable on, at least one webpage bearing the search number and related to the product based on the search number in the trending keyword data collection.

As the trending keyword data collection is a dynamical data collection whose content varies with passage of time, at different times, the feature and search number combined linguistic units displayed, and discerned by a user, on a page of the product review website 4 can differ. In certain embodiments, the trending keyword data collection is updated by the remote computing device 1 on a real-time basis, or at predetermined time intervals, such as on a daily basis. In certain embodiments, a feature and search number combined linguistic unit can be a hypertext linking to at least one page displaying the reviews of the goods or service that contain the feature point corresponding to the feature and search number combined linguistic unit, or the reviews of all the goods and/or services on the product review website that contain the feature point corresponding to the feature and search number combined linguistic unit. Accordingly, a user can click on a single hypertext to browse through the reviews of different goods and/or services.

In addition, the information in the trending keyword data collection, in addition to serving as the basis of determining the priority of the trending keyword(s), also serves as reference information for the various opinion evaluation system for advertisement placement evaluation. In certain embodiments, the trending keyword data collection includes, in addition to the priority and search number information of each trending keyword, product information corresponding to each trending keyword, such as product names. In certain embodiments, the trending keyword data collection is organized with multiple product levels. For example, the trending keyword data collection can have product boxes that correspond to different product categories, each product box includes product layers corresponding to the goods and/or service(s) in the product category. The remote computing device 1 can, in certain embodiments under the condition that the user has logged in the product review website 4, generate a user interest list storing the product(s) that interests a user of the product review website 4, such as the goods and/or service(s) the user has browsed on the product review website 4; retrieve, according to the user interest list and the trending keyword data collection, the trending keyword(s) corresponding to such goods and/or service(s) and the information of the goods and/or service(s) corresponding to such trending keyword(s), including the positive, negative and special feature points of the trending-keyword-corresponding goods and/or service(s); and generate, and/or update pages of the product review website 4 with the information of the goods and/or service(s) corresponding to such trending keyword(s). In certain embodiments, the remote computing device 1 can retrieve the matching piece(s) of product data in the product data collection 182 based on the user interest list, and therefore obtain the feature point information of the product(s) corresponding to the piece(s) of product data. For example, a user may have searched for a computer product on the product review website 4, and the computer product is classified in a product layer in a computer box of the trending keyword data collection and corresponds to multiple trending keywords. Accordingly, information of the product(s) related to the computer product can be recommended by the remote computing device 1 to the user. In certain embodiments, the user interest list is incorporated with the product data collection 182. By generating at least one page of the product review website 4 that contains the information of the goods and/or service(s) corresponding to the trending keyword(s) related to at least one piece of goods or service that is designated as interested by a user, such as one in the user interest list, and/or updating at least one page of the product review website 4 with the information of the goods and/or service(s) corresponding to the trending keyword(s), the remote computing device 1 can recommend to a user, and place on the page(s), advertisements of the goods and/or service(s) corresponding to the trending keyword(s).

In certain embodiments, the product review website 4 recommends to a user and places advertisement on the page(s) thereon for at least one product in the user interest list through a keyword advertisement algorithm executed by the remote computing device 1. A keyword advertisement module of the remote computing device 1 applies the keyword advertisement algorithm on at least one product in the user interest list by comparing a first product name of a first product in the user interest list with each second product name of each second product in the trending keyword data collection for similarity; determining a first numeral value positively correlative to the product name similarity; comparing each feature point of the first product with each trending keyword in the trending keyword data collection for similarity; determining a second numeral value positively correlative to the feature point-trending keyword similarity; and generating a key advertisement value based on the first and second numeral values. In certain embodiments, the keyword advertisement module is further configured to determine whether the first and the second products are in the same product category declared by the remote computing device 1, and in response to determining the first and second products are in the same product category, for example, a 3C, Home appliance, stationery category, etc., raise the first numeral value. In certain embodiments, the key advertisement value is generated by multiplying the first numeral value by the second numeral value. In certain embodiments, the keyword advertisement algorithm includes a name similarity value algorithm through which the first numeral value is determined, and a keyword similarity algorithm through which the second numeral value is determined, and the respective determination of the first and second numeral values are mutually independent. The keyword advertisement module is further configured to select at least one product having a keyword advertisement value higher or equal to a threshold or ranking, generate at least one piece of advertisement information of the product, and generate or update pages of the product review website 4 with the piece of advertisement information. As the respective determination of the first and second numeral values are mutually independent, in certain embodiments, if the second numeral value is preset to 1, the advertisement generation and recommendation would be based only on the product name similarity and not on the keyword similarity; and in certain embodiments, as referred supra, when the keyword similarity serves as the basis of advertisement generation and recommendation, correlation analysis can be performed for advertisement placement on the feature point(s) of a product and the trending keyword(s), by which horizontal linking is established between the feature point(s) and the trending keyword(s).

For example, assuming a user searches for “reusable food bag” on a page, either a search page or a product page with a search bar, on the product review website 4, either on a computer or a mobile application, similar or same product names can be outputted by and shown on the product review website 4, among which the user may click on one product name, for example, “reusable silicone food bag”, and the search behavior, searched text and selection of the user is tracked and stored in the user interest list of the user. Upon receipt of the user request for the “reusable silicone food bag”, the remote computing device 1 retrieves the matching piece(s) of product data in the product data collection 182, and thereby avails the product and review pages of the exemplary “reusable silicone food bag” to the user, which may contain positive and negative feature points, such as “environmentally friendly”, “reusable”, “easy to clean”, “microwaveable” and “open with one hand”, and “leaks when filled with liquid”, respectively, while a special feature point may not exist when the positive feature(s) and the negative feature(s) do not have intersection. Thereafter, the remote computing device 1 can search for and identify the product(s) designated with trending keywords sharing text similarity with the feature points of the “reusable silicone food bag”, for example, a silicone cotton swab product having positive feature points of “environmentally friendly”, “reusable”, “colorful” and “makeup removal” and a negative feature point of “does not absorb water and needs more cleaning time”, and an eco-friendly shoe product having a special feature point of “environmentally friendly”, positive feature points of “comfortable and eco-friendly”, “environmentally friendly material” and “earth love” and a negative feature point of “environmentally friendly but crumbly”.

Accordingly, even though the product categories of the reusable silicone food bag, the silicone cotton swab product and the eco-friendly shoe product may be different, as the feature points of “reusable” and “environmentally friendly” are shared by the “reusable silicone food bag” and the silicone cotton swab product, and “reusable” is share by the “reusable silicone food bag” and the eco-friendly shoe product, product information and review information thereof by other users of the silicone cotton swab product and the eco-friendly shoe product may be displayed at an advertisement section of a page of the product review website 4 the user is browsing on. Such advertisement product and review information can include positive, negative and special feature point information and virtual button and/or hypertext thereof, by which the user can be guided to, by clicking thereon, a detailed information page of the product(s) of the advertisement, for example, a page of the official website of the silicone cotton swab product or the eco-friendly shoe product, a page showing the review(s) of the silicone cotton swab product or the eco-friendly shoe product, etc., for better advertising and marketing effects.

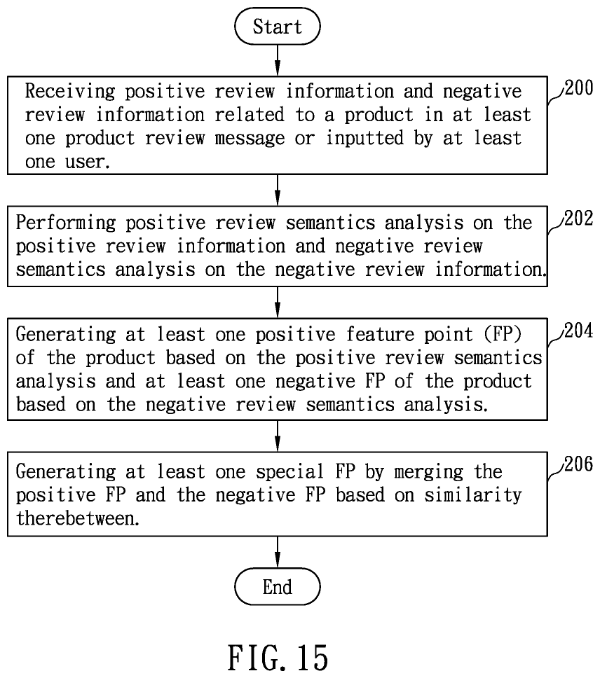

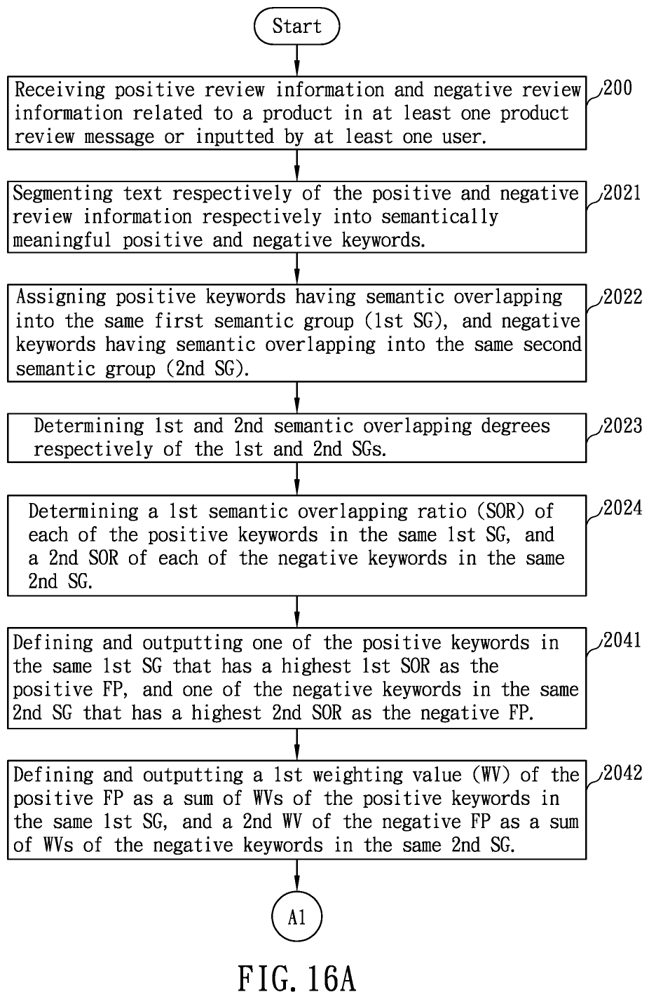

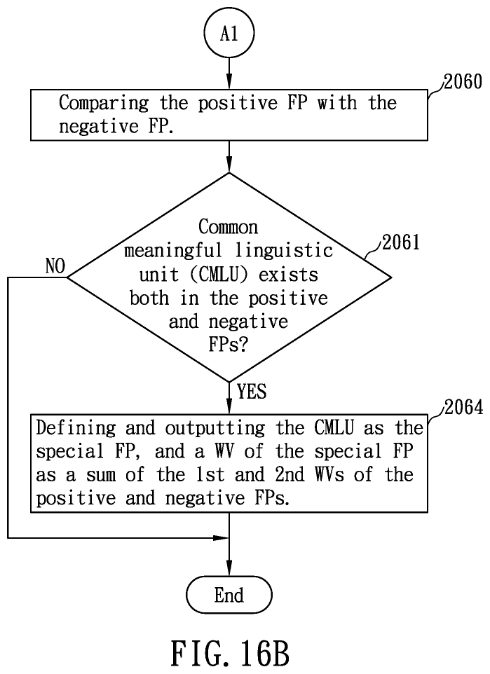

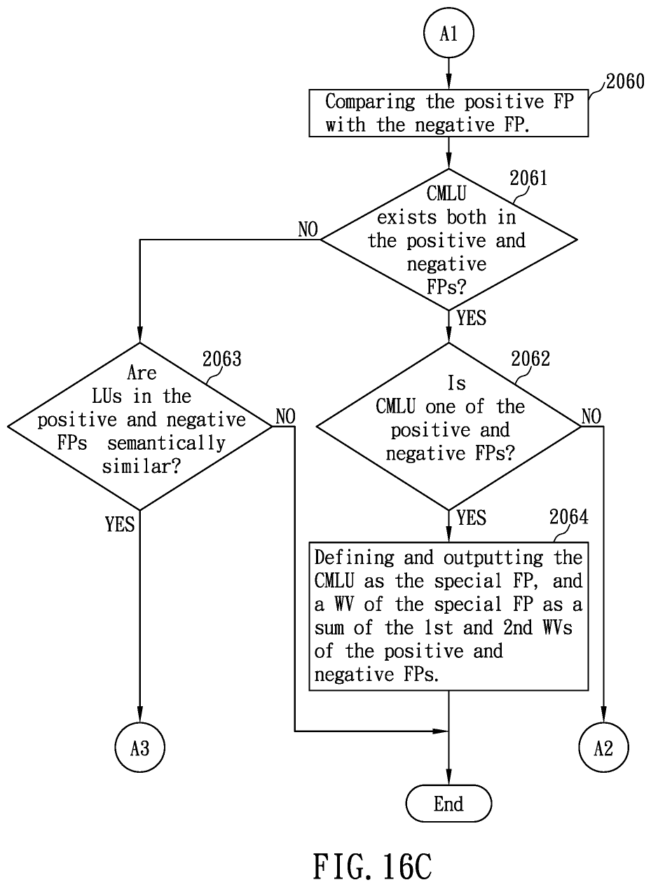

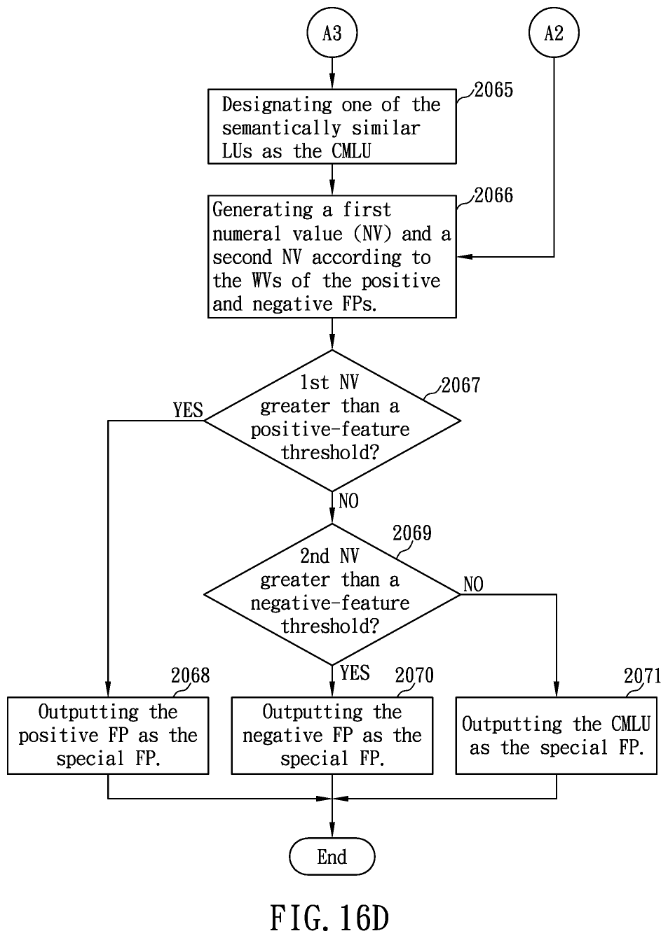

Certain aspects of the present disclosure are directed to methods for generating at least one special feature point based on positive and negative feature points. FIGS. 15-16D show flowcharts of methods for generating at least one special feature point based on positive and negative feature points. In certain embodiments, the methods according to the present disclosure, including those exemplarily shown in FIGS. 15-16D, can be implemented on or by the various opinion evaluation system, the remote computing device 1, and/or at least one client device 2 according to the present disclosure. It should be particularly noted that, unless otherwise stated in the present disclosure, the sequence of the steps and/or procedures of the methods according to the present disclosure can be varied as desired, such as being arranged in a sequential order different from those described in, and/or the figures and flowcharts of, the present disclosure, and is not necessarily in or limited to the sequential order of the description in, and/or the figures and flowcharts of, the present disclosure.

Referring to FIG. 15, at procedure 200, one or more first computing devices being the remote computing device 1 and/or at least one client device 2 will receive a piece of positive review information related to a product and a piece of negative review information from one or more second computing devices being at least one client device 2 and/or the remote computing device 1 through one or more product review messages, for example, but not limited to, a product review message having the piece of positive review information related to the product and having the piece of negative review information related to the product, at least one first product review message having the piece of positive review information related to the product from at least one first client device 2 and at least one second product review message different from or the same as the first product review message and having the piece of negative review information from at least one second client device 2 the same or different from the first client device 2, etc., which product review message(s) may be received, for example, by the remote computing device 1 from one or more client devices 2, by one or more client devices 2 from one or more client devices 2, by one or more client devices 2 from the remote computing device 1 and one or more client devices 2, etc. In certain embodiments, the at least one first computing device being at least one client device 2 and/or the remote computing device 1 can receive the piece of positive review information related to the product and the piece of negative review information related to the product by being inputted with the positive and negative information by at least one user. At procedure 202, one or more semantics analysis modules of one or more first computing devices, for example, the semantics analysis module 17, will perform positive review semantics analysis on the positive review information and perform negative review semantics analysis on the negative review information. In certain embodiments, the positive semantics analysis includes segmenting the text of the positive review information into semantically meaningful positive keywords, and the negative review semantics analysis includes segmenting the text of the negative review information into semantically meaningful negative keywords. At procedure 204, one or more feature point generation modules of one or more of the first and second computing devices, for example, the feature point generation module 16, will generate at least one positive feature point based on the positive review semantics analysis and generate at least one negative feature point based on the negative review semantics analysis. At procedure 206, the one or more feature point generation modules of one or more of the first and second computing devices will merge the positive feature point and the negative feature point based on the similarity therebetween to generate at least one special feature point. However, the present disclosure is not limited thereto, and the receipt of one product review message may be before, at the same time or later than the receipt of another product review message or the positive or negative review semantics analysis, and the positive review semantics analysis may be performed before, at the same time or later than the negative review semantics analysis.

Referring to FIG. 16A, in certain embodiments, procedure 202 of performing positive and negative review semantics analysis on the positive and negative review information further includes procedures 2021 to 2024. At procedure 2021, the one or more semantics analysis modules, for example, the semantics analysis module 17 and/or the semantics analysis module of at least one client device 2, will perform positive semantics analysis on the positive review information, for example, segmenting text of the positive review information, to generate a plurality of semantically meaningful positive keywords, and perform negative semantics analysis on the negative review information, for example, segmenting text of the negative review information, to generate a plurality of semantically meaningful negative keywords. At procedure 2022, the one or more semantics analysis modules will assign positive keywords that have semantic overlapping into the same first semantic group, and assign negative keywords that have semantic overlapping into the same second semantic group. At procedure 2023, the one or more semantics analysis modules will determine a first semantic overlapping degree of the first semantic group, wherein the first semantic overlapping degree is any semantic overlapping between any two positive keywords in the same first semantic group; and determine a second semantic overlapping degree of the second semantic group, wherein the second semantic overlapping degree is any semantic overlapping between any two negative keywords in the same second semantic group. At procedure 2024, the one or more semantics analysis modules will determine a first semantic overlapping ratio of each of the positive keywords in the same first semantic group, wherein the first semantic overlapping ratio is a ratio of any semantic overlapping between the positive keyword and any other positive keyword in the same first semantic group to the first semantic overlapping degree, and determine a second semantic overlapping ratio of each of the negative keywords in the same second semantic group, wherein the second semantic overlapping ratio is a ratio of any semantic overlapping between the negative keyword and any other negative keyword in the same second semantic group to the second semantic overlapping degree. However, the present disclosure is not limited thereto, and any procedure above generating or performed to the positive keywords may be performed before, at the same time or after any procedure above generating or performed to the negative keywords.

Referring to FIG. 16A, procedure 204 of generating at least one positive feature point and at least one negative feature point based on the positive and negative review semantics analysis further includes procedures 2041 to 2042. At procedure 2041, the one or more feature point generation modules, for example, the feature point generation module 16 and/or the feature point generation module(s) of at least one client device 2, will define and output one of the positive keywords in the same first semantic group that has a highest first semantic overlapping ratio among the first semantic overlapping ratios as the positive feature point, and one of the negative keywords in the same second semantic group that has a highest second semantic overlapping ratio among the second semantic overlapping ratios as the negative feature point. At procedure 2042, the one or more feature point generation modules will define and output a first weighting value of the positive feature point as a sum of weighting values of the positive keywords in the same first semantic group to which the positive feature point belongs, and a second weighting value of the negative feature point as a sum of weighting values of the negative keywords in the same second semantic group to which the negative feature point belongs. However, the present disclosure is not limited thereto, and any procedure above that generates or is performed to the positive feature point may be performed before, at the same time or after any procedure above that generates or is performed to the negative feature point.

Referring to FIG. 16B, in certain embodiments, procedure 206 of merging the positive and negative feature points based on the similarity therebetween and generating at least one special feature point based on the merge further includes procedures 2060, 2061 and 2064. At procedure 2060, one or more semantics analysis modules of one or more of the first and second computing devices, for example, the semantics analysis module 17 and/or the semantics analysis module of at least one client device 2, will compare the positive feature point with the negative feature point. At procedure 2061, the one or more semantics analysis modules of one or more of the first and second computing devices will determine whether at least one common meaningful linguistic unit exists both in the positive feature point and the negative feature point based on the comparison. At procedure 2064, in response to determining at least one common meaningful linguistic unit exists both in the positive feature point and the negative feature point, the one or more feature point generation modules, for example, the feature point generation module 16 and/or the feature point generation module of at least one client device 2, will define and output the common meaningful linguistic unit as the special feature point, and define a weighting value of the special feature point as a sum of the first weighting value of the positive feature point and the second weighting value of the negative feature point. Further, in response to determining no common meaningful linguistic unit exists both in the positive feature point and the negative feature point, the remote computing device 1 and/or the at least one client device 2 can end the special feature point generation procedures.

Referring to FIGS. 16C and 16D, in certain embodiments, procedure 206 further includes procedures 2062, 2063 and 2065-2071. At procedure 2062, in response to determining at least one common meaningful linguistic unit exists both in the positive feature and negative feature points, the one or more semantics analysis modules of one or more of the first and second computing devices will determine whether the common meaningful linguistic unit is a positive feature point or a negative feature point, that is, whether the positive feature point is the negative feature point. In response to determining no common meaningful linguistic unit exists both in the positive feature point and the negative feature point, proceed to procedure 2063. In response to determining the common meaningful linguistic unit is a positive feature point or a negative feature point, that is, the positive feature point is the negative feature point, proceed to procedure 2064. In response to determining the common meaningful linguistic unit is not a positive feature point and not a negative feature point, proceed to procedure 2066. However, the present disclosure is not limited thereto. In certain embodiments, the sequence of procedures 2061 and 2062 may be reversed with the semantics analysis module 17 and/or the semantics analysis module of at least one client device 2 determining, in response to determining the positive feature point is not the negative feature point, whether at least one common meaningful linguistic unit exists both in the positive and negative feature points.

At procedure 2063, the one or more semantics analysis modules of one or more of the first and second computing devices, for example, the semantics analysis module 17 and/or the semantics analysis module of at least one client device 2, will determine whether at least one first linguistic unit in at least one positive feature point and at least one second linguistic unit in at least one negative feature point are semantically similar linguistic units. In response to determining there are semantically similar linguistic units, and therefore the positive and negative feature points are semantically similar feature points, proceed to procedure 2065. In response to determining there is no semantically similar linguistic units, end the special feature point generation procedure. At procedure 2065, the one or more semantics analysis modules of one or more of the first and second computing devices will designate one of the semantically similar linguistic units as the common meaningful linguistic unit, and the method proceeds to procedures 2066-2071 to generate at least one special feature point that is either the positive feature point, the negative feature point, or the common meaningful linguistic unit based on a balance curve algorithm. For example, a hypernym is designated as the common meaningful linguistic unit when the rest of the semantically similar linguistic units are hyponyms thereto, or when all semantically similar linguistic units are synonyms, one that is determined to be used most often is designated. In certain embodiments, procedures 2063 and 2065 may be omitted, and the special feature point generation procedure is ended in response to determining there is no common meaningful linguistic unit in procedure 2061.

Referring to FIG. 16D, in certain embodiments, at procedure 2066, the one or more feature point generation modules will generate a first numeral value according to the weighting values of the positive and negative feature points corresponding to the common meaningful linguistic unit, and a second numeral value according to the weighting values of the positive and negative feature points corresponding to the common meaningful linguistic unit. At procedure 2067, the one or more feature point generation modules will determine whether the first numeral value is greater than a predetermined positive-feature threshold. At procedure 2068, in response to determining the first numeral value is greater than the positive-feature threshold, the one or more feature point generation modules will define and output the positive feature point as the special feature point. In response to determining the first numeral value is not greater than the positive-feature threshold, proceed to procedure 2069. At procedure 2069, the one or more feature point generation modules will determine whether the second numeral value is greater than a predetermined negative-feature threshold. At procedure 2070, in response to determining the second numeral value is greater than the negative-feature threshold, the one or more feature point generation modules will define and output the negative feature point as the special feature point. At procedure 2071, in response to determining the second numeral value is not greater than the negative-feature threshold, the one or more feature point generation modules will define and output the common meaningful linguistic unit as the special feature point.

However, the present disclosure is not limited thereto, and the procedure 2067 may be performed before or after procedure 2069. In certain embodiments the one or more feature point generation modules will first determine whether the second numeral value is greater than the predetermined negative-feature threshold; in response to determining the second numeral value is greater than the predetermined negative-feature threshold, define and output the negative feature point as the special feature point; in response to determining the second numeral value is not greater than the predetermined negative-feature threshold, determine whether the first numeral value is greater than a predetermined positive-feature threshold; in response to determining the first numeral value is greater than a predetermined positive-feature threshold, define and output the positive feature point as the special feature point; and in response to determining the first numeral value is not greater than a predetermined positive-feature threshold, define and output the common meaningful linguistic unit as the special feature point. In certain embodiments, procedure 2065 may be performed before, at the same time or after any of procedures 2066-2070.

Certain aspects of the present disclosure are related to a non-transitory computer readable medium storing computer executable code. The computer executable code, when executed at one or more processer, can perform the tasks of the modules and the methods as described supra. In certain embodiments, the non-transitory computer readable medium can be implemented as the storage device 14 of the remote computing device 1 and/or the storage device of at least one client device 2, and may include at least one physical or virtual storage media. However, the present disclosure is not limited thereto.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A various opinion evaluation system, comprising one or more computing devices comprising one or more processors and one or more storage devices storing computer executable code, wherein each of the one or more computing devices is a remote computing device or a client device communicable with the remote computing device, and the computer executable code, when executed at the one or more processors, is configured to:
receive a piece of positive review information related to a product and a piece of negative review information related to the product through at least one product review message or inputted at the one or more computing devices by at least one user;
perform positive review semantics analysis on the positive review information, and perform negative review semantics analysis on the negative review information;
generate at least one positive feature point of the product based on the positive review semantics analysis, and generate at least one negative feature point of the product based on the negative review semantics analysis; and
generate at least one special feature point by merging the positive feature point and the negative feature point based on similarity therebetween.

2. The system according to claim 1, wherein the computer executable code of the one or more computing devices, when executed at the one or more processors, is configured to:
segment text of the positive review information into a plurality of semantically meaningful positive keywords, and segment text of the negative review information into a plurality of semantically meaningful negative keywords; and
assign at least two of the semantically meaningful positive keywords that have semantic overlapping into the same first semantic group, and assign at least two of the semantically meaningful negative keywords that have semantic overlapping into the same second semantic group.

3. The system according to claim 2, wherein the computer executable code of the one or more computing devices, when executed at the one or more processors, is configured to:
determine a first semantic overlapping degree of the first semantic group, wherein the first semantic overlapping degree is any semantic overlapping between any two semantically meaningful positive keywords in the same first semantic group;
determine a second semantic overlapping degree of the second semantic group, wherein the second semantic overlapping degree is any semantic overlapping between any two semantically meaningful negative keywords in the same second semantic group;
determine a first semantic overlapping ratio of each of the at least two semantically meaningful positive keywords in the same first semantic group, wherein the first semantic overlapping ratio is a ratio of any semantic overlapping between the semantically meaningful positive keyword and any other semantically meaningful positive keyword in the same first semantic group to the first semantic overlapping degree; and
determine a second semantic overlapping ratio of each of the at least two semantically meaningful negative keywords in the same second semantic group, wherein the second semantic overlapping ratio is a ratio of any semantic overlapping between the semantically meaningful negative keyword and any other semantically meaningful negative keyword in the same second semantic group to the second semantic overlapping degree.

4. The system according to claim 3, wherein the computer executable code of the one or more computing devices, when executed at the one or more processors, is configured to:
define one of the semantically meaningful positive keywords in the same first semantic group that has a highest first semantic overlapping ratio among the first semantic overlapping ratios as the positive feature point;
define one of the semantically meaningful negative keywords in the same second semantic group that has a highest second semantic overlapping ratio among the second semantic overlapping ratios as the negative feature point;
define a first weighting value of the positive feature point as a sum of weighting values of the semantically meaningful positive keywords in the same first semantic group to which the positive feature point belongs; and
define a second weighting value of the negative feature point as a sum of weighting values of the semantically meaningful negative keywords in the same second semantic group to which the negative feature point belongs.

5. The system according to claim 1, wherein the computer executable code of the one or more computing devices, when executed at the one or more processors, is configured to:
compare the positive feature point with the negative feature point;
determine whether at least one common meaningful linguistic unit exists both in the positive feature point and the negative feature point based on the comparison; and
in response to determining at least one common meaningful linguistic unit exists both in the positive feature point and the negative feature point, define the common meaningful linguistic unit as the special feature point, and define a weighting value of the special feature point as a sum of a first weighting value of the positive feature point and a second weighting value of the negative feature point.

6. The system according to claim 1, wherein the computer executable code of the one or more computing devices, when executed at the one or more processors, is configured to:
generate a first numeral value according to a first weighting value of the positive feature point and a second weighting value of the negative feature point, and generate a second numeral value according to the first weighting value of the positive feature point and the second weighting value of the negative feature point;
compare the positive feature point with the negative feature point;
determine whether at least one common meaningful linguistic unit exists both in the positive feature point and the negative feature point based on the comparison;
determine whether the common meaningful linguistic unit is the positive feature point or the negative feature point;
in response to determining the common meaningful linguistic unit is the positive feature point or the negative feature point, define the positive feature point or the negative feature point as the special feature point, and define a weighting value of the special feature point as a sum of the first weighting value of the positive feature point and the second weighting value of the negative feature point;
in response to determining the common meaningful linguistic unit is not the positive feature point and not the negative feature point, determine whether the first numeral value is greater than a predetermined positive-feature threshold, and determine whether the second numeral value is greater than a predetermined negative-feature threshold;
in response to determining the first numeral value is greater than the predetermined positive-feature threshold, define the positive feature point as the special feature point;
in response to determining the second numeral value is greater than the predetermined negative-feature threshold, define the negative feature point as the special feature point; and
in response to determining the first numeral value is smaller than the predetermined positive-feature threshold and the second numeral value is smaller than the predetermined negative-feature threshold, define the common meaningful linguistic unit as the special feature point.

7. The system according to claim 1, wherein the computer executable code of the one or more computing devices, when executed at the one or more processors, is configured to:
generate a first numeral value according to a first weighting value of the positive feature point and a second weighting value of the negative feature point, and generate a second numeral value according to the first weighting value of the positive feature point and the second weighting value of the negative feature point;
compare the positive feature point with the negative feature point;
determine whether at least one common meaningful linguistic unit exists both in the positive feature point and the negative feature point based on the comparison;
determine whether the common meaningful linguistic unit is the positive feature point or the negative feature point;
in response to determining the common meaningful linguistic unit is the positive feature point or the negative feature point, define the positive feature point or the negative feature point as the special feature point, and define a weighting value of the special feature point as a sum of the first weighting value of the positive feature point and the second weighting value of the negative feature point;
in response to determining no common meaningful linguistic unit exists both in the positive and negative feature points, determine whether at least one first linguistic unit in the positive feature point and at least one second linguistic unit in the negative feature point are semantically similar linguistic units;
in response to determining the first and second linguistic units are semantically similar linguistic units, designate one of the first and second linguistic units as the common meaningful linguistic unit, and determine whether the first numeral value is greater than a predetermined positive-feature threshold and whether the second numeral value is greater than a predetermined negative-feature threshold;
in response to determining the first numeral value is greater than the predetermined positive-feature threshold, define the positive feature point as the special feature point;
in response to determining the second numeral value is greater than the predetermined negative-feature threshold, define the negative feature point as the special feature point; and
in response to determining the first numeral value is smaller than the predetermined positive-feature threshold and the second numeral value is smaller than the predetermined negative-feature threshold, define the common meaningful linguistic unit as the special feature point.

8. A product special feature point generation method, comprising:
receiving, by one or more first computing devices, a piece of positive review information related to a product and a piece of negative review information related to the product inputted at the one or more first computing devices by at least one user or through at least one product review message from one or more second computing devices, wherein each of the first and second computing devices is a remote computing device or a client device communicable with the remote computing device;
performing, by one or more semantics analysis modules of the one or more first computing devices, positive review semantics analysis on the positive review information and negative review semantics analysis on the negative review information;
generating, by one or more feature point generation modules of one or more of the first and second computing devices, at least one positive feature point of the product based on the positive review semantics analysis and at least one negative feature point of the product based on the negative review semantics analysis; and
generating, by the one or more feature point generation modules, at least one special feature point by merging the positive feature point and the negative feature point based on similarity therebetween.

9. The method according to claim 8, wherein the step of performing positive review semantics analysis on the positive review information and negative review semantics analysis on the negative review information includes:
segmenting, by the one or more semantics analysis modules, text of the positive review information into a plurality of semantically meaningful positive keywords, and segmenting text of the negative review information into a plurality of semantically meaningful negative keywords; and
assigning, by the one or more semantics analysis modules, at least two of the semantically meaningful positive keywords that have semantic overlapping into the same first semantic group, and at least two of the semantically meaningful negative keywords that have semantic overlapping into the same second semantic group.

10. The method according to claim 9, wherein the step of performing positive review semantics analysis on the positive review information and negative review semantics analysis on the negative review information further includes:
determining, by the one or more semantics analysis modules, a first semantic overlapping degree of the first semantic group, wherein the first semantic overlapping degree is any semantic overlapping between any two semantically meaningful positive keywords in the same first semantic group;
determining, by the one or more semantics analysis modules, a second semantic overlapping degree of the second semantic group, wherein the second semantic overlapping degree is any semantic overlapping between any two semantically meaningful negative keywords in the same second semantic group;
determining, by the one or more semantics analysis modules, a first semantic overlapping ratio of each of the at least two semantically meaningful positive keywords in the same first semantic group, wherein the first semantic overlapping ratio is a ratio of any semantic overlapping between the semantically meaningful positive keyword and any other semantically meaningful positive keyword in the same first semantic group to the first semantic overlapping degree; and
determining, by the one or more semantics analysis modules, a second semantic overlapping ratio of each of the at least two semantically meaningful negative keywords in the same second semantic group, wherein the second semantic overlapping ratio is a ratio of any semantic overlapping between the semantically meaningful negative keyword and any other semantically meaningful negative keyword in the same second semantic group to the second semantic overlapping degree.

11. The method according to claim 10, wherein the step of generating the at least one positive feature point and at least one negative feature point includes:
defining, by the one or more feature point generation modules, one of the semantically meaningful positive keywords in the same first semantic group that has a highest first semantic overlapping ratio among the first semantic overlapping ratios as the positive feature point;
defining, by the one or more feature point generation modules, one of the semantically meaningful negative keywords in the same second semantic group that has a highest second semantic overlapping ratio among the second semantic overlapping ratios as the negative feature point;
defining, by the one or more feature point generation modules, a first weighting value of the positive feature point as a sum of weighting values of the semantically meaningful positive keywords in the same first semantic group to which the positive feature point belongs; and
defining, by the one or more feature point generation modules, a second weighting value of the negative feature point as a sum of weighting values of the semantically meaningful negative keywords in the same second semantic group to which the negative feature point belongs.

12. The method according to claim 8, the step of generating at least one special feature point further includes:
comparing, by one or more semantics analysis modules of one or more of the first and second computing devices, the positive feature point with the negative feature point;
determining, by the one or more semantics analysis modules of one or more of the first and second computing devices, whether at least one common meaningful linguistic unit exists both in the positive feature point and the negative feature point based on the comparison; and
in response to determining at least one common meaningful linguistic unit exists both in the positive feature point and the negative feature point, defining, by the one or more feature point generation modules, the common meaningful linguistic unit as the special feature point, and defining, by the one or more feature point generation modules, a weighting value of the special feature point as a sum of a first weighting value of the positive feature point and a second weighting value of the negative feature point.

13. The method according to claim 8, the step of generating at least one special feature point further includes:
generating, by the one or more feature point generation modules, a first numeral value according to a first weighting value of the positive feature point and a second weighting value of the negative feature point, and a second numeral value according to the first weighting value of the positive feature point and the second weighting value of the negative feature point;
comparing, by one or more semantics analysis modules of one or more of the first and second computing devices, the positive feature point with the negative feature point;
determining, by the one or more semantics analysis modules of one or more of the first and second computing devices, whether at least one common meaningful linguistic unit exists both in the positive feature point and the negative feature point based on the comparison;
determining, by the one or more semantics analysis modules of one or more of the first and second computing devices, whether the common meaningful linguistic unit is the positive feature point or the negative feature point;
in response to determining the common meaningful linguistic unit is the positive feature point or the negative feature point, defining, by the one or more feature point generation modules, the positive feature point or the negative feature point as the special feature point, and defining, by the one or more feature point generation modules, a weighting value of the special feature point as a sum of the first weighting value of the positive feature point and the second weighting value of the negative feature point;
in response to determining the common meaningful linguistic unit is not the positive feature point and not the negative feature point, determining, by the one or more feature point generation modules, whether the first numeral value is greater than a predetermined positive-feature threshold, and determining, by the one or more feature point generation modules, whether the second numeral value is greater than a predetermined negative-feature threshold;
in response to determining the first numeral value is greater than the predetermined positive-feature threshold, defining, by the one or more feature point generation modules, the positive feature point as the special feature point;
in response to determining the second numeral value is greater than the predetermined negative-feature threshold, defining, by the one or more feature point generation modules, the negative feature point as the special feature point; and
in response to determining the first numeral value is smaller than the predetermined positive-feature threshold and the second numeral value is smaller than the predetermined negative-feature threshold, defining, by the one or more feature point generation modules, the common meaningful linguistic unit as the special feature point.

14. The method according to claim 8, the step of generating at least one special feature point further includes:
generating, by the one or more feature point generation modules, a first numeral value according to a first weighting value of the positive feature point and a second weighting value of the negative feature point, and a second numeral value according to the first weighting value of the positive feature point and the second weighting value of the negative feature point;
comparing, by one or more semantics analysis modules of one or more of the first and second computing devices, the positive feature point with the negative feature point;
determining, by the one or more semantics analysis modules of one or more of the first and second computing devices, whether at least one common meaningful linguistic unit exists both in the positive feature point and the negative feature point based on the comparison;
determining, by the one or more semantics analysis modules of one or more of the first and second computing devices, whether the common meaningful linguistic unit is the positive feature point or the negative feature point;
in response to determining the common meaningful linguistic unit is the positive feature point or the negative feature point, defining, by the one or more feature point generation modules, the positive feature point or the negative feature point as the special feature point, and defining, by the one or more feature point generation modules, a weighting value of the special feature point as a sum of the first weighting value of the positive feature point and the second weighting value of the negative feature point;
in response to determining no common meaningful linguistic unit exists both in the positive feature point and the negative feature point, determining, by the one or more semantics analysis modules of one or more of the first and second computing devices, whether at least one first linguistic unit in the positive feature point and at least one second linguistic unit in the negative feature point are semantically similar linguistic units;
in response to determining the first and second linguistic units are semantically similar linguistic units, designating, by the one or more semantics analysis modules of one or more of the first and second computing devices, one of the first and second linguistic units as the common meaningful linguistic unit, and determining, by the one or more feature point generation modules, whether the first numeral value is greater than a predetermined positive-feature threshold and whether the second numeral value is greater than a predetermined negative-feature threshold;
in response to determining the first numeral value is greater than the predetermined positive-feature threshold, defining, by the one or more feature point generation modules, the positive feature point as the special feature point;
in response to determining the second numeral value is greater than the predetermined negative-feature threshold, defining, by the one or more feature point generation modules, the negative feature point as the special feature point; and
in response to determining the first numeral value is smaller than the predetermined positive-feature threshold and the second numeral value is smaller than the predetermined negative-feature threshold, defining, by the one or more feature point generation modules, the common meaningful linguistic unit as the special feature point.

15. A non-transitory computer readable medium storing computer executable code, wherein the computer executable code, when executed at one or more processors of one or more of a remote computing device and at least one client device communicable with the remote computing device for special feature point generation, is configured to:
receive a piece of positive review information related to a product and a piece of negative review information related to the product through at least one product review message or inputted at the one or more of the remote computing device and the at least one client device by at least one user;
perform positive review semantics analysis on the positive review information, and perform negative review semantics analysis on the negative review information;
generate at least one positive feature point of the product based on the positive review semantics analysis, and generate at least one negative feature point of the product based on the negative review semantics analysis; and
generate at least one special feature point by merging the positive feature point and the negative feature point based on similarity therebetween.

16. The non-transitory computer readable medium according to claim 15, wherein the computer executable code, when executed at the one or more processors, is configured to:
segment text of the positive review information into a plurality of semantically meaningful positive keywords, and text of the negative review information into a plurality of semantically meaningful negative keywords; and
assign at least two of the semantically meaningful positive keywords that have semantic overlapping into the same first semantic group, and at least two of the semantically meaningful negative keywords that have semantic overlapping into the same second semantic group.

17. The non-transitory computer readable medium according to claim 16, wherein the computer executable code, when executed at the one or more processors, is configured to:
determine a first semantic overlapping degree of the first semantic group, wherein the first semantic overlapping degree is any semantic overlapping between any two semantically meaningful positive keywords in the same first semantic group;
determine a second semantic overlapping degree of the second semantic group, wherein the second semantic overlapping degree is any semantic overlapping between any two semantically meaningful negative keywords in the same second semantic group;
determine a first semantic overlapping ratio of each of the at least two semantically meaningful positive keywords in the same first semantic group, wherein the first semantic overlapping ratio is a ratio of any semantic overlapping between the semantically meaningful positive keyword and any other semantically meaningful positive keyword in the same first semantic group to the first semantic overlapping degree; and
determine a second semantic overlapping ratio of each of the at least two semantically meaningful negative keywords in the same second semantic group, wherein the second semantic overlapping ratio is a ratio of any semantic overlapping between the semantically meaningful negative keyword and any other semantically meaningful negative keyword in the same second semantic group to the second semantic overlapping degree.

18. The non-transitory computer readable medium according to claim 17, wherein the computer executable code, when executed at the one or more processors, is configured to:
define one of the semantically meaningful positive keywords in the same first semantic group that has a highest first semantic overlapping ratio among the first semantic overlapping ratios as the positive feature point;
define one of the semantically meaningful negative keywords in the same second semantic group that has a highest second semantic overlapping ratio among the second semantic overlapping ratios as the negative feature point;
define a first weighting value of the positive feature point as a sum of weighting values of the semantically meaningful positive keywords in the same first semantic group to which the positive feature point belongs; and
define a second weighting value of the negative feature point as a sum of weighting values of the semantically meaningful negative keywords in the same second semantic group to which the negative feature point belongs.

19. The non-transitory computer readable medium according to claim 15, wherein the computer executable code, when executed at the one or more processors, is configured to:
compare the positive feature point with the negative feature point;
determine whether at least one common meaningful linguistic unit exists both in the positive feature point and the negative feature point based on the comparison; and
in response to determining at least one common meaningful linguistic unit exists both in the positive feature point and the negative feature point, define the common meaningful linguistic unit as the special feature point, and define a weighting value of the special feature point as a sum of a first weighting value of the positive feature point and a second weighting value of the negative feature point.

20. The non-transitory computer readable medium according to claim 15, wherein the computer executable code, when executed at the one or more processors, is configured to:
generate a first numeral value according to a first weighting value of the positive feature point and a second weighting value of the negative feature point, and a second numeral value according to the first weighting value of the positive feature point and the second weighting value of the negative feature point;
compare the positive feature point with the negative feature point;
determine whether at least one common meaningful linguistic unit exists both in the positive feature point and the negative feature point based on the comparison;
determine whether the common meaningful linguistic unit is the positive feature point or the negative feature point;
in response to determining the common meaningful linguistic unit is the positive feature point or the negative feature point, define the positive feature point or the negative feature point as the special feature point, and define a weighting value of the special feature point as a sum of the first weighting value of the positive feature point and the second weighting value of the negative feature point;
in response to determining the common meaningful linguistic unit is not the positive feature point and not the negative feature point, determine whether the first numeral value is greater than a predetermined positive-feature threshold, and determine whether the second numeral value is greater than a predetermined negative-feature threshold;
in response to determining the first numeral value is greater than the predetermined positive-feature threshold, define the positive feature point as the special feature point;
in response to determining the second numeral value is greater than the predetermined negative-feature threshold, define the negative feature point as the special feature point; and
in response to determining the first numeral value is smaller than the predetermined positive-feature threshold and the second numeral value is smaller than the predetermined negative-feature threshold, define the common meaningful linguistic unit as the special feature point.
